(19) United States
(12) Patent Application Publication
(10) Pub. No.: US 2026/0046867 A1
(43) Pub. Date: Feb. 12, 2026

(54) TECHNIQUES FOR RADIO RESOURCE CONTROL CONFIGURATION OF UPLINK CONTROL AND UPLINK MUTING PATTERN IN SUB-BAND FULL-DUPLEX

(71) Applicant: QUALCOMM Incorporated, San Diego, CA (US)

(72) Inventors: Abdelrahman Mohamed IBRAHIM, San Diego, CA (US); Muhammad Sayed Khairy ABDELGHAFFAR, San Jose, CA (US); Qian ZHANG, Basking Ridge, NJ (US)

(21) Appl. No.: 19/291,458

(22) Filed: Aug. 5, 2025

Related U.S. Application Data
(60) Provisional application No. 63/680,538, filed on Aug. 7, 2024.

(51) Int. Cl. H04W 72/1268; H04W 72/231

(52) U.S. Cl. CPC H04W 72/1268; H04W 72/231

(57) ABSTRACT

Methods, systems, and devices for wireless communication are described. Techniques described herein provide for uplink transmission procedures and techniques to utilize rate matching from one or more resource muting patterns. A UE may receive a physical uplink shared channel (PUSCH) configuration indicating rate matching information. From the rate matching information, the UE may determine a frequency-based rate matching pattern for one or two symbols where rate matching is to be applied. A UE may send a PUSCH transmission to a network entity in accordance with the frequency-based rate matching pattern.

### CROSS REFERENCE

The present Application for Patent claims the benefit of U.S. Provisional Ser. No. 63/680,538 by IBRAHIM et al., entitled “TECHNIQUES FOR RADIO RESOURCE CONTROL CONFIGURATION OF UPLINK CONTROL AND UPLINK MUTING PATTERN IN SUB-BAND FULL-DUPLEX,” filed Aug. 7, 2024, and assigned to the assignee hereof. U.S. Provisional Ser. No. 63/680,538 is expressly incorporated by reference herein in its entirety.

### INTRODUCTION

The following relates to wireless communications that pertain to techniques for radio resource control (RRC) configuration of physical uplink shared channel (PUSCH) and uplink muting pattern in sub-band full-duplex (SBFD).

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be referred to as user equipment (UE).

### SUMMARY

The systems, methods, and devices of this disclosure each have several innovative aspects, no single one of which is solely responsible for the desirable attributes disclosed herein.

A method by a network entity is described. The method may include receiving physical uplink shared channel (PUSCH) configuration information including rate matching information, determining, based on the rate matching information, a frequency-based rate matching pattern for one or more PUSCH transmissions, where the frequency-based rate matching pattern includes one or two symbols to which rate matching is to be applied, and transmitting a PUSCH transmission based on the frequency-based rate matching pattern.

A network entity is described. The network entity may include one or more memories storing processor executable code, and one or more processors coupled with the one or more memories. The one or more processors may individually or collectively be operable to execute the code to cause the network entity to receive PUSCH configuration information including rate matching information, determine, based on the rate matching information, a frequency-based rate matching pattern for one or more PUSCH transmissions, where the frequency-based rate matching pattern includes one or two symbols to which rate matching is to be applied, and transmit a PUSCH transmission based on the frequency-based rate matching pattern.

Another network entity is described. The network entity may include means for receiving PUSCH configuration information including rate matching information, means for determining, based on the rate matching information, a frequency-based rate matching pattern for one or more PUSCH transmissions, where the frequency-based rate matching pattern includes one or two symbols to which rate matching is to be applied, and means for transmitting a PUSCH transmission based on the frequency-based rate matching pattern.

A non-transitory computer-readable medium storing code is described. The code may include instructions executable by one or more processors to receive PUSCH configuration information including rate matching information, determine, based on the rate matching information, a frequency-based rate matching pattern for one or more PUSCH transmissions, where the frequency-based rate matching pattern includes one or two symbols to which rate matching is to be applied, and transmit a PUSCH transmission based on the frequency-based rate matching pattern.

In some examples of the method, network entities, and non-transitory computer-readable medium described herein, the PUSCH configuration information includes a parameter indicative that the rate matching information may be configured for the network entity.

In some examples of the method, network entities, and non-transitory computer-readable medium described herein, the rate matching information may be indicative of one or two uplink symbols associated with the frequency-based rate matching pattern.

In some examples of the method, network entities, and non-transitory computer-readable medium described herein, the rate matching information includes a respective location for each uplink symbol of the one or two uplink symbols among a set of multiple uplink symbols.

In some examples of the method, network entities, and non-transitory computer-readable medium described herein, locations for each uplink symbol of the set of multiple uplink symbols may be indicated in a bitmap and the set of multiple uplink symbols in a slot may be in accordance with the bitmap.

In some examples of the method, network entities, and non-transitory computer-readable medium described herein, the set of multiple uplink symbols represents a slot.

In some examples of the method, network entities, and non-transitory computer-readable medium described herein, the set of multiple uplink symbols includes 14 symbols.

In some examples of the method, network entities, and non-transitory computer-readable medium described herein, the one or two uplink symbols include a first uplink symbol and a second uplink symbol and a threshold quantity of symbols exist between the first uplink symbol and the second uplink symbol.

In some examples of the method, network entities, and non-transitory computer-readable medium described herein, the respective location for the first uplink symbol may be a first location and the respective location for the second uplink symbol may be a second location.

In some examples of the method, network entities, and non-transitory computer-readable medium described herein, the one or two uplink symbols include a first uplink symbol and the rate matching information includes a location of the first uplink symbol among a first subset of two or more uplink symbols of a set of multiple uplink symbols.

In some examples of the method, network entities, and non-transitory computer-readable medium described herein, the one or two uplink symbols includes a first uplink symbol and a second uplink symbol, the location of the first uplink symbol and a location of the second uplink symbol may be indicated by an index included in the rate matching information, and the index may be associated with a symbol pattern.

In some examples of the method, network entities, and non-transitory computer-readable medium described herein, the set of multiple uplink symbols represents a slot.

In some examples of the method, network entities, and non-transitory computer-readable medium described herein, the set of multiple uplink symbols includes 14 symbols.

In some examples of the method, network entities, and non-transitory computer-readable medium described herein, the one or two uplink symbols include a second uplink symbol and a second location of the second uplink symbol among the set of multiple uplink symbols may be based on the location of the first uplink symbol.

In some examples of the method, network entities, and non-transitory computer-readable medium described herein, the one or two uplink symbols include a second uplink symbol and a second location of the second uplink symbol among the set of multiple uplink symbols may be based on an offset from the location of the first uplink symbol.

In some examples of the method, network entities, and non-transitory computer-readable medium described herein, the rate matching information includes the offset.

In some examples of the method, network entities, and non-transitory computer-readable medium described herein, the set of multiple uplink symbols represents a slot.

In some examples of the method, network entities, and non-transitory computer-readable medium described herein, the set of multiple uplink symbols includes 14 symbols.

In some examples of the method, network entities, and non-transitory computer-readable medium described herein, the one or two uplink symbols may be based on relative locations of uplink symbols in a slot.

In some examples of the method, network entities, and non-transitory computer-readable medium described herein, the one or two uplink symbols include a first uplink symbol, a location of first uplink symbol among a set of multiple uplink symbols may be an Nth uplink symbol among the set of multiple uplink symbols, and N may be an integer greater than or equal to 1.

In some examples of the method, network entities, and non-transitory computer-readable medium described herein, the set of multiple uplink symbols represents a slot.

In some examples of the method, network entities, and non-transitory computer-readable medium described herein, the set of multiple uplink symbols includes 14 symbols.

In some examples of the method, network entities, and non-transitory computer-readable medium described herein, the one or two uplink symbols include a second uplink symbol, a location of second uplink symbol among a set of multiple uplink symbols may be an Mth uplink symbol among the set of multiple uplink symbols, and M may be an integer greater than N.

In some examples of the method, network entities, and non-transitory computer-readable medium described herein, the set of multiple uplink symbols represents a slot.

In some examples of the method, network entities, and non-transitory computer-readable medium described herein, the set of multiple uplink symbols includes 14 symbols.

In some examples of the method, network entities, and non-transitory computer-readable medium described herein, the one or two uplink symbols includes a first uplink symbol and a second uplink symbol and locations of the first uplink symbol and the second uplink symbol may be fixed.

In some examples of the method, network entities, and non-transitory computer-readable medium described herein, the rate matching information includes a respective location for each uplink symbol of the one or two uplink symbols among a set of multiple uplink symbols and the respective location for each uplink symbol of the one or two uplink symbols may be based on a PUSCH allocation associated with the PUSCH transmission.

In some examples of the method, network entities, and non-transitory computer-readable medium described herein, the set of multiple uplink symbols represents a slot.

In some examples of the method, network entities, and non-transitory computer-readable medium described herein, the set of multiple uplink symbols includes 14 symbols.

In some examples of the method, network entities, and non-transitory computer-readable medium described herein, the one or two uplink symbols includes a first uplink symbol and a second uplink symbol, locations of the first uplink symbol and the second uplink symbol may be defined via respective location parameters included in the rate matching information, and the respective location parameters indicate the locations of the first uplink symbol and the second uplink symbol based on demodulation reference signal position within a PUSCH allocation associated with the PUSCH transmission.

In some examples of the method, network entities, and non-transitory computer-readable medium described herein, the one or two uplink symbols includes a first uplink symbol and a second uplink symbol, locations of the first uplink symbol and the second uplink symbol may be defined via respective location parameters included in the rate matching information, and the respective location parameters indicate the locations of the first uplink symbol and the second uplink symbol may be based on a length of a PUSCH allocation associated with the PUSCH transmission.

In some examples of the method, network entities, and non-transitory computer-readable medium described herein, the one or two uplink symbols includes a first uplink symbol and a second uplink symbol, locations of the first uplink symbol and the second uplink symbol may be defined via respective location parameters included in the rate matching information, and the respective location parameters indicate the locations of the first uplink symbol and the second uplink symbol may be based on positions of symbols that do not include a demodulation reference signal or a phase tracking reference signal within a PUSCH allocation associated with the PUSCH transmission.

In some examples of the method, network entities, and non-transitory computer-readable medium described herein, the rate matching information includes an index, a respective location for each uplink symbol of the one or two uplink symbols may be based on the index, and the index corresponds to a row of a time domain resource allocation table.

In some examples of the method, network entities, and non-transitory computer-readable medium described herein, rate matching information includes an index corresponding to particular information and the particular information includes a particular PUSCH mapping type, a particular slot location of the PUSCH transmission, a particular starting symbol, a particular length of the PUSCH transmission, and a respective location for each uplink symbol of the one or two uplink symbols.

In some examples of the method, network entities, and non-transitory computer-readable medium described herein, the index corresponds to a row of a time domain resource allocation table that includes the particular information.

In some examples of the method, network entities, and non-transitory computer-readable medium described herein, a respective location for each uplink symbol the one or two uplink symbols may be based on a start and length indicator value.

In some examples of the method, network entities, and non-transitory computer-readable medium described herein, the start and length indicator value may be for a time domain allocation corresponding to the PUSCH configuration information.

In some examples of the method, network entities, and non-transitory computer-readable medium described herein, the frequency-based rate matching pattern may be configured during only a sub-band full-duplex (SBFD) slot in which the PUSCH transmission may be scheduled.

In some examples of the method, network entities, and non-transitory computer-readable medium described herein, a maximum bandwidth available for the frequency-based rate matching pattern may be an uplink sub-band in the SBFD slot.

In some examples of the method, network entities, and non-transitory computer-readable medium described herein, the frequency-based rate matching pattern may be configured during either a sub-band full-duplex (SBFD) slot or a non-SBFD slot in which the PUSCH transmission may be scheduled.

In some examples of the method, network entities, and non-transitory computer-readable medium described herein, a maximum bandwidth available for the frequency-based rate matching pattern in either the SBFD slot or the non-SBFD slot may be an uplink sub-band in the SBFD slot.

In some examples of the method, network entities, and non-transitory computer-readable medium described herein, a maximum bandwidth available for the frequency-based rate matching pattern may be based on an uplink sub-band in an SBFD slot in which the PUSCH transmission may be scheduled, or an uplink sub-band in a non-SBFD slot in which the PUSCH transmission may be scheduled.

Some examples of the method, network entities, and non-transitory computer-readable medium described herein may further include operations, features, means, or instructions for receiving information indicative of a maximum bandwidth available for the frequency-based rate matching pattern in either the SBFD slot or the non-SBFD slot, where the maximum bandwidth may be at least equal to an uplink sub-band in the SBFD slot.

In some examples of the method, network entities, and non-transitory computer-readable medium described herein, the frequency-based rate matching pattern may be a comb-2 pattern that may be configured with a resource element (RE) offset.

Some examples of the method, network entities, and non-transitory computer-readable medium described herein may further include operations, features, means, or instructions for receiving the RE offset via a configuration message.

In some examples of the method, network entities, and non-transitory computer-readable medium described herein, the RE offset may be a non-signaled RE offset.

Some examples of the method, network entities, and non-transitory computer-readable medium described herein may further include operations, features, means, or instructions for receiving a configuration message including a periodicity and a slot offset associated with the frequency-based rate matching pattern.

Some examples of the method, network entities, and non-transitory computer-readable medium described herein may further include operations, features, means, or instructions for receiving a configuration message including a time domain pattern associated with the frequency-based rate matching pattern.

In some examples of the method, network entities, and non-transitory computer-readable medium described herein, the frequency-based rate matching pattern may be based on one or more fields and the one or more fields include a first field indicative of whether waveform switching may be based on the frequency-based rate matching pattern, or a second field indicative of whether PUSCH repetition type-A, PUSCH repetition type-B, transport block processing over multi-slot (TBoMS) PUSCH, or downlink control information (DCI) scheduling multiple PUSCH may be based on the frequency-based rate matching pattern.

In some examples of the method, network entities, and non-transitory computer-readable medium described herein, the method, apparatuses, and non-transitory computer-readable medium may include further operations, features, means, or instructions for applying rate matching to the one or two symbols based on the frequency-based rate matching pattern.

In some examples of the method, network entities, and non-transitory computer-readable medium described herein, the frequency-based rate matching pattern may be based on a comb-2 pattern for both discrete Fourier transform spread orthogonal frequency division multiplexing and cyclic prefix orthogonal frequency division multiplexing.

Some examples of the method, network entities, and non-transitory computer-readable medium described herein may further include operations, features, means, or instructions for receiving radio resource control (RRC) information, where the RRC information includes the PUSCH configuration information.

A method by a network entity is described. The method may include transmitting PUSCH configuration information including rate matching information and receiving a PUSCH transmission based on a frequency-based rate matching pattern for one or more PUSCH transmissions, where the frequency-based rate matching pattern includes one or two symbols to which rate matching is to be applied.

A network entity is described. The network entity may include one or more memories storing processor executable code, and one or more processors coupled with the one or more memories. The one or more processors may individually or collectively be operable to execute the code to cause the network entity to transmit PUSCH configuration information including rate matching information and receive a PUSCH transmission based on a frequency-based rate matching pattern for one or more PUSCH transmissions, where the frequency-based rate matching pattern includes one or two symbols to which rate matching is to be applied.

Another network entity is described. The network entity may include means for transmitting PUSCH configuration information including rate matching information and means for receiving a PUSCH transmission based on a frequency-based rate matching pattern for one or more PUSCH transmissions, where the frequency-based rate matching pattern includes one or two symbols to which rate matching is to be applied.

A non-transitory computer-readable medium storing code is described. The code may include instructions executable by one or more processors to transmit PUSCH configuration information including rate matching information and receive a PUSCH transmission based on a frequency-based rate matching pattern for one or more PUSCH transmissions, where the frequency-based rate matching pattern includes one or two symbols to which rate matching is to be applied.

In some examples of the method, network entities, and non-transitory computer-readable medium described herein, the PUSCH configuration information includes a parameter indicative that the rate matching information may be configured for a second network entity.

In some examples of the method, network entities, and non-transitory computer-readable medium described herein, the rate matching information may be indicative of one or two uplink symbols associated with the frequency-based rate matching pattern.

In some examples of the method, network entities, and non-transitory computer-readable medium described herein, the rate matching information includes a respective location for each uplink symbol of the one or two uplink symbols among a set of multiple uplink symbols.

In some examples of the method, network entities, and non-transitory computer-readable medium described herein, locations for each uplink symbol of the set of multiple uplink symbols may be indicated in a bitmap and the set of multiple uplink symbols in a slot may be in accordance with the bitmap.

In some examples of the method, network entities, and non-transitory computer-readable medium described herein, the set of multiple uplink symbols represents a slot.

In some examples of the method, network entities, and non-transitory computer-readable medium described herein, the set of multiple uplink symbols includes 14 symbols.

In some examples of the method, network entities, and non-transitory computer-readable medium described herein, the one or two uplink symbols include a first uplink symbol and a second uplink symbol and a threshold quantity of symbols exist between the first uplink symbol and the second uplink symbol.

In some examples of the method, network entities, and non-transitory computer-readable medium described herein, the respective location for the first uplink symbol may be a first location and the respective location for the second uplink symbol may be a second location.

In some examples of the method, network entities, and non-transitory computer-readable medium described herein, the one or two uplink symbols include a first uplink symbol and the rate matching information includes a location of the first uplink symbol among a first subset of two or more uplink symbols of a set of multiple uplink symbols.

In some examples of the method, network entities, and non-transitory computer-readable medium described herein, the one or two uplink symbols includes a first uplink symbol and a second uplink symbol, the location of the first uplink symbol and a location of the second uplink symbol may be indicated by an index included in the rate matching information, and the index may be associated with a symbol pattern.

In some examples of the method, network entities, and non-transitory computer-readable medium described herein, the set of multiple uplink symbols represents a slot.

In some examples of the method, network entities, and non-transitory computer-readable medium described herein, the set of multiple uplink symbols includes 14 symbols.

In some examples of the method, network entities, and non-transitory computer-readable medium described herein, the one or two uplink symbols include a second uplink symbol and a second location of the second uplink symbol among the set of multiple uplink symbols may be based on the location of the first uplink symbol.

In some examples of the method, network entities, and non-transitory computer-readable medium described herein, the one or two uplink symbols include a second uplink symbol and a second location of the second uplink symbol among the set of multiple uplink symbols may be based on an offset from the location of the first uplink symbol.

In some examples of the method, network entities, and non-transitory computer-readable medium described herein, the rate matching information includes the offset.

In some examples of the method, network entities, and non-transitory computer-readable medium described herein, the set of multiple uplink symbols represents a slot.

In some examples of the method, network entities, and non-transitory computer-readable medium described herein, the set of multiple uplink symbols includes 14 symbols.

In some examples of the method, network entities, and non-transitory computer-readable medium described herein, the one or two uplink symbols may be based on relative locations of uplink symbols in a slot.

In some examples of the method, network entities, and non-transitory computer-readable medium described herein, the one or two uplink symbols include a first uplink symbol, a location of first uplink symbol among a set of multiple uplink symbols may be an Nth uplink symbol among the set of multiple uplink symbols, and N may be an integer greater than or equal to 1.

In some examples of the method, network entities, and non-transitory computer-readable medium described herein, the set of multiple uplink symbols represents a slot.

In some examples of the method, network entities, and non-transitory computer-readable medium described herein, the one or two uplink symbols include a second uplink symbol, a location of second uplink symbol among a set of multiple uplink symbols may be an Mth uplink symbol among the set of multiple uplink symbols, and M may be an integer greater than N.

In some examples of the method, network entities, and non-transitory computer-readable medium described herein, the set of multiple uplink symbols represents a slot.

In some examples of the method, network entities, and non-transitory computer-readable medium described herein, the set of multiple uplink symbols includes 14 symbols.

In some examples of the method, network entities, and non-transitory computer-readable medium described herein, the one or two uplink symbols includes a first uplink symbol and a second uplink symbol and locations of the first uplink symbol and the second uplink symbol may be fixed.

In some examples of the method, network entities, and non-transitory computer-readable medium described herein, the rate matching information includes a respective location for each uplink symbol of the one or two uplink symbols among a set of multiple uplink symbols and the respective location for each uplink symbol of the one or two uplink symbols may be based on a PUSCH allocation associated with the PUSCH transmission.

In some examples of the method, network entities, and non-transitory computer-readable medium described herein, the set of multiple uplink symbols represents a slot.

In some examples of the method, network entities, and non-transitory computer-readable medium described herein, the set of multiple uplink symbols includes 14 symbols.

In some examples of the method, network entities, and non-transitory computer-readable medium described herein, the one or two uplink symbols includes a first uplink symbol and a second uplink symbol, locations of the first uplink symbol and the second uplink symbol may be defined via respective location parameters included in the rate matching information, and the respective location parameters indicate the locations of the first uplink symbol and the second uplink symbol based on demodulation reference signal position within a PUSCH allocation associated with the PUSCH transmission.

In some examples of the method, network entities, and non-transitory computer-readable medium described herein, the one or two uplink symbols includes a first uplink symbol and a second uplink symbol, locations of the first uplink symbol and the second uplink symbol may be defined via respective location parameters included in the rate matching information, and the respective location parameters indicate the locations of the first uplink symbol and the second uplink symbol may be based on a length of a PUSCH allocation associated with the PUSCH transmission.

In some examples of the method, network entities, and non-transitory computer-readable medium described herein, the one or two uplink symbols includes a first uplink symbol and a second uplink symbol, locations of the first uplink symbol and the second uplink symbol may be defined via respective location parameters included in the rate matching information, and the respective location parameters indicate the locations of the first uplink symbol and the second uplink symbol may be based on positions of symbols that do not include a demodulation reference signal or a phase tracking reference signal within a PUSCH allocation associated with the PUSCH transmission.

In some examples of the method, network entities, and non-transitory computer-readable medium described herein, the rate matching information includes an index, a respective location for each uplink symbol of the one or two uplink symbols may be based on the index, and the index corresponds to a row of a time domain resource allocation table.

In some examples of the method, network entities, and non-transitory computer-readable medium described herein, rate matching information includes an index corresponding to particular information and the particular information includes a particular PUSCH mapping type, a particular slot location of the PUSCH transmission, a particular starting symbol, a particular length of the PUSCH transmission, and a respective location for each uplink symbol of the one or two uplink symbols.

In some examples of the method, network entities, and non-transitory computer-readable medium described herein, the index corresponds to a row of a time domain resource allocation table that includes the particular information.

In some examples of the method, network entities, and non-transitory computer-readable medium described herein, a respective location for each uplink symbol the one or two uplink symbols may be based on a start and length indicator value.

In some examples of the method, network entities, and non-transitory computer-readable medium described herein, the start and length indicator value may be for a time domain allocation corresponding to the PUSCH configuration information.

In some examples of the method, network entities, and non-transitory computer-readable medium described herein, the frequency-based rate matching pattern may be configured during only a sub-band full-duplex (SBFD) slot in which the PUSCH transmission may be scheduled.

In some examples of the method, network entities, and non-transitory computer-readable medium described herein, a maximum bandwidth available for the frequency-based rate matching pattern may be an uplink sub-band in the SBFD slot.

In some examples of the method, network entities, and non-transitory computer-readable medium described herein, the frequency-based rate matching pattern may be configured during either a sub-band full-duplex (SBFD) slot or a non-SBFD slot in which the PUSCH transmission may be scheduled.

In some examples of the method, network entities, and non-transitory computer-readable medium described herein, a maximum bandwidth available for the frequency-based rate matching pattern in either the SBFD slot or the non-SBFD slot may be an uplink sub-band in the SBFD slot.

In some examples of the method, network entities, and non-transitory computer-readable medium described herein, a maximum bandwidth available for the frequency-based rate matching pattern may be based on an uplink sub-band in an SBFD slot in which the PUSCH transmission may be scheduled, or an uplink sub-band in a non-SBFD slot in which the PUSCH transmission may be scheduled.

Some examples of the method, network entities, and non-transitory computer-readable medium described herein may further include operations, features, means, or instructions for transmitting information indicative of a maximum bandwidth available for the frequency-based rate matching pattern in either the SBFD slot or the non-SBFD slot, where the maximum bandwidth may be at least equal to an uplink sub-band in the SBFD slot.

In some examples of the method, network entities, and non-transitory computer-readable medium described herein, the frequency-based rate matching pattern may be a comb-2 pattern that may be configured with a resource element (RE) offset.

Some examples of the method, network entities, and non-transitory computer-readable medium described herein may further include operations, features, means, or instructions for transmitting the RE offset via a configuration message.

In some examples of the method, network entities, and non-transitory computer-readable medium described herein, the RE offset may be a non-signaled RE offset.

Some examples of the method, network entities, and non-transitory computer-readable medium described herein may further include operations, features, means, or instructions for transmitting a configuration message including a periodicity and a slot offset associated with the frequency-based rate matching pattern.

Some examples of the method, network entities, and non-transitory computer-readable medium described herein may further include operations, features, means, or instructions for transmitting a configuration message including a time domain pattern associated with the frequency-based rate matching pattern.

In some examples of the method, network entities, and non-transitory computer-readable medium described herein, the frequency-based rate matching pattern may be based on one or more fields and the one or more fields include a first field indicative of whether waveform switching may be based on the frequency-based rate matching pattern, or a second field indicative of whether PUSCH repetition type-A, PUSCH repetition type-B, transport block processing over multi-slot (TBoMS) PUSCH, or DCI scheduling multiple PUSCH may be based on the frequency-based rate matching pattern.

In some examples of the method, network entities, and non-transitory computer-readable medium described herein, the PUSCH transmission may be in accordance with rate matching to the one or two symbols based on the frequency-based rate matching pattern.

In some examples of the method, network entities, and non-transitory computer-readable medium described herein, the frequency-based rate matching pattern may be based on a comb-2 pattern for both discrete Fourier transform spread orthogonal frequency division multiplexing and cyclic prefix orthogonal frequency division multiplexing.

Some examples of the method, network entities, and non-transitory computer-readable medium described herein may further include operations, features, means, or instructions for transmitting RRC information, where the RRC information includes the PUSCH configuration information.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for radio resource control (RRC) configuration of physical uplink shared channel (PUSCH) and uplink muting pattern in sub-band full-duplex (SBFD) in accordance with one or more aspects of the present disclosure.

FIG. 2 shows an example of a wireless communications system that supports techniques for RRC configuration of PUSCH and UL muting pattern in SBFD in accordance with one or more aspects of the present disclosure.

FIGS. 3A, 3B, and 3C show examples of resource diagrams that support techniques for RRC configuration of PUSCH and UL muting pattern in SBFD in accordance with one or more aspects of the present disclosure.

FIGS. 4A and 4B show examples of resource diagrams that support techniques for RRC configuration of PUSCH and UL muting pattern in SBFD in accordance with one or more aspects of the present disclosure.

FIGS. 5A, 5B, and 5C show respective examples of resource diagrams that support techniques for RRC configuration of PUSCH and UL muting pattern in SBFD in accordance with one or more aspects of the present disclosure.

FIG. 6 shows an example of a process flow diagram that supports techniques for RRC configuration of PUSCH and UL muting pattern in SBFD in accordance with one or more aspects of the present disclosure.

FIGS. 7 and 8 show block diagrams of devices that support techniques for RRC configuration of PUSCH and UL muting pattern in SBFD in accordance with one or more aspects of the present disclosure.

FIG. 9 shows a block diagram of a communications manager that supports techniques for RRC configuration of PUSCH and UL muting pattern in SBFD in accordance with one or more aspects of the present disclosure.

FIG. 10 shows a diagram of a system including a device that supports techniques for RRC configuration of PUSCH and UL muting pattern in SBFD in accordance with one or more aspects of the present disclosure.

FIGS. 11 and 12 show block diagrams of devices that support techniques for RRC configuration of PUSCH and UL muting pattern in SBFD in accordance with one or more aspects of the present disclosure.

FIG. 13 shows a block diagram of a communications manager that supports techniques for RRC configuration of PUSCH and UL muting pattern in SBFD in accordance with one or more aspects of the present disclosure.

FIG. 14 shows a diagram of a system including a device that supports techniques for RRC configuration of PUSCH and UL muting pattern in SBFD in accordance with one or more aspects of the present disclosure.

FIGS. 15 and 16 show flowcharts illustrating methods that support techniques for RRC configuration of PUSCH and UL muting pattern in SBFD in accordance with one or more aspects of the present disclosure.

### DETAILED DESCRIPTION

In some examples, a wireless communications system may support one or more duplex modes (e.g., half duplex, full duplex, subband full duplex (SBFD), among other examples). Devices operating in a full duplex mode may generate or experience cross-link interference (CLI). Such CLI may include CLI between user equipments (UEs) (e.g., intra-cell CLI, inter-cell CLI), and interference between network entities (inter-network entity CLI). In some examples, wireless devices may perform CLI measurements to detect and mitigate CLI (e.g., one network entity may perform CLI measurements to detect inter network entity CLI from another network entity). However, if other devices are transmitting during such CLI measurements, then such CLI measurements may fail, or may be inaccurate, resulting in less effective or ineffective CLI mitigation, poor channel performance, failed transmissions, decreased reliability of wireless signaling, increased system latency, and decreased user experience.

Uplink muting is a technique used in wireless communication systems to alleviate CLI. It refers to silencing the transmission, or “muting” from the UE to a network entity during certain time intervals in order to prevent or minimize interference with other links. If the network determines there's going to be interference, it may instruct the UE to halt its transmissions temporarily thereby reducing interference between simultaneous multiple transmissions. Uplink muting effectively ensures a more reliable communication service with less interference, leading to high-speed and low-latency performance. In some aspects, uplink muting may be accomplished via uplink rate matching. When uplink muting is active (i.e., the device is not allowed to transmit), rate-matching algorithms take into account that resources are not available for transmission and adjust the data rate accordingly for transmissions that may still occur outside of the muted resources. Rate-matching can therefore help to optimize resource usage while uplink muting occurs, thus allowing for more efficient operations under different network conditions and requirements.

Techniques described herein provide for uplink transmission procedures and techniques to utilize rate matching from one or more resource muting patterns. A UE may receive a physical uplink shared channel (PUSCH) configuration indicating rate matching information. From the rate matching information, the UE may determine a frequency-based rate matching pattern for one or two symbols where rate matching is to be applied. A UE may send a PUSCH transmission to a network entity in accordance with the frequency-based rate matching pattern.

Aspects of the disclosure are initially described in the context of wireless communications systems. Aspects of the disclosure are further illustrated by and described with reference to spatial relation diagrams and process flows. Aspects of the disclosure are further illustrated by and described with reference to apparatus diagrams, system diagrams, and flowcharts that relate to techniques for radio resource control (RRC) configuration of PUSCH and uplink muting pattern in SBFD.

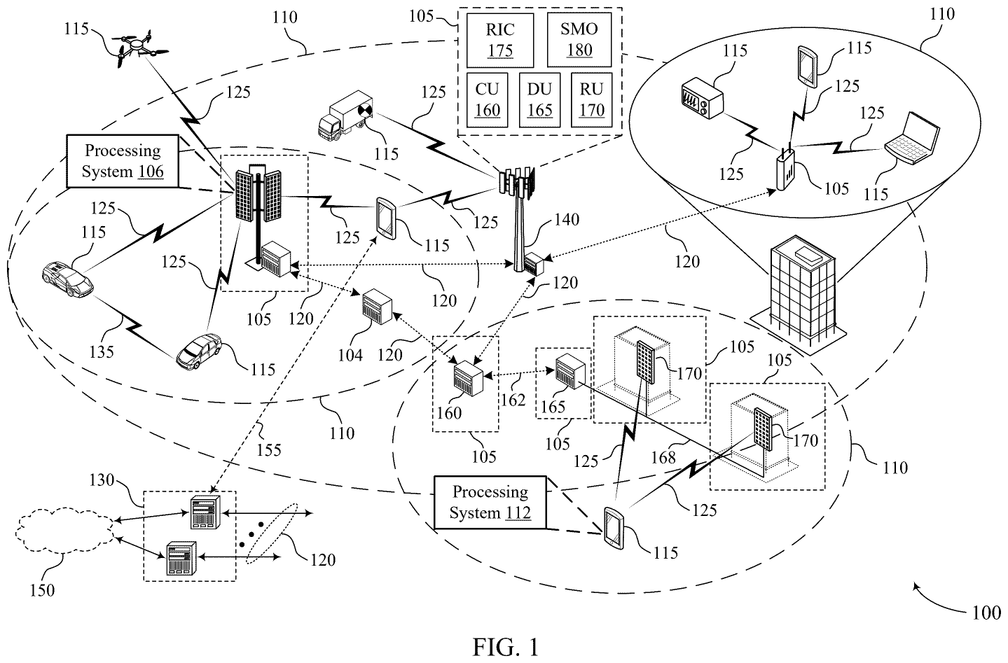

FIG. 1 shows an example of a wireless communications system 100 that supports techniques for RRC configuration of PUSCH and UL muting pattern in SBFD in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network(s) described with reference to FIG. 1. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein. For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz may be referred to as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

Techniques described herein provide for uplink transmission procedures and techniques to utilize rate matching from one or more resource muting patterns. A UE may receive a PUSCH configuration indicating rate matching information. From the rate matching information, the UE may determine a frequency-based rate matching pattern for one or two symbols where rate matching is to be applied. A UE may send a PUSCH transmission to a network entity in accordance with the frequency-based rate matching pattern.

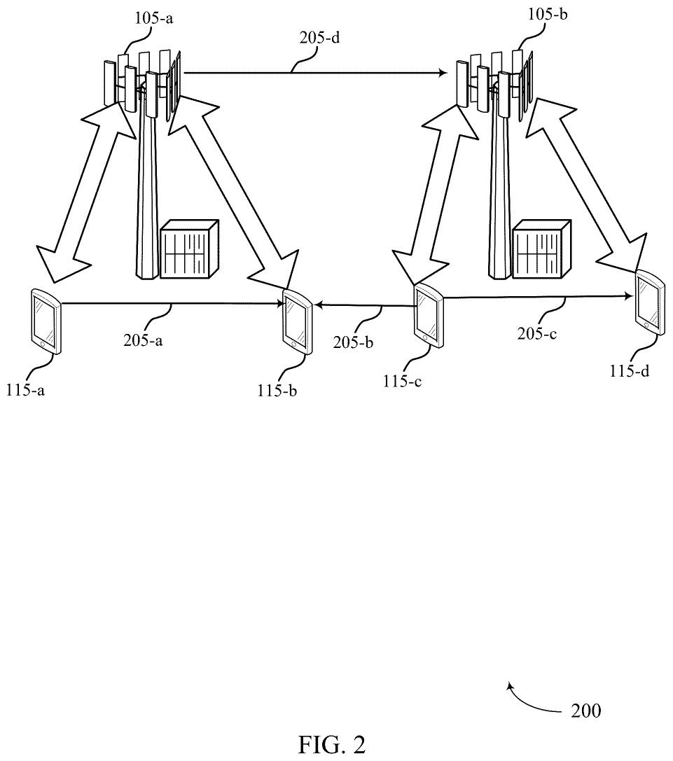

FIG. 2 shows an example of a wireless communications system 200 that supports techniques for RRC configuration of PUSCH and UL muting pattern in SBFD in accordance with one or more aspects of the present disclosure. Wireless communications system 200 may implement, or be implemented by, aspects of wireless communications system 100. For example, wireless communications system 200 may include one or more network entities 105 (e.g., network entity 105-a and network entity 105-b), and one or more UEs 115 (e.g., UE 115-a, UE 115-b, UE 115-c, and UE 115-d), which may be examples of corresponding devices described with reference to FIG. 1. Each network entity 105 may serve one or more UEs (e.g., network entity 105-a may serve UE 115-a and UE 115-b, which may be located in a cell or coverage area corresponding to network entity 105-a, and network entity 105-b may serve UE 115-c and UE 115-d, which may be located in a cell or coverage area corresponding to network entity 105-b).

One or more devices in wireless communications system 200 may support full duplex operations (e.g., SBFD operations in a time domain carrier or intra-band carrier aggregation scenario). For example, network entity 105-b may support SBFD operations, and may perform simultaneous transmission and reception of uplink signaling (e.g., from UE 115-c) and downlink signaling (e.g., to UE 115-d). Uplink and downlink signaling may be scheduled (e.g., partially or fully within a component carrier bandwidth) to include downlink resources (e.g., one or more downlink subbands and one or more uplink subbands within the same slot, which may be separated by one or more guard bands). Such SBFD deployments may support increased uplink duty cycles, leading to latency reduction (e.g., because it is possible to transmit uplink signaling in uplink subbands in downlink only slots or flexile slots, which can enable uplink latency savings), and uplink coverage improvements. SBFD deployments may also enhance system capacity, resource utilization, and spectrum efficiency, and may enable flexible and dynamic uplink and downlink resource adaptations according to uplink and downlink traffic in a robust manner. Some SBFD deployments may support SBFD operations at a UE 115. For example, UE 115-a may simultaneously transmit uplink signaling to network entity 105-a and receive downlink signaling from network entity 105-a.

One or more devices operation in a full duplex mode (e.g., a SBFD mode) may generate or experience CLI (e.g., CLI 205). Such CLI may include inter-subband CLI, inter-cell CLI, inter-UE CLI, intra-cell CLI, and inter-gNB CLI (e.g., in-band inter-gNB CLI). CLI 205 (e.g., inter-cell, intra-cell, inter-UE, inter-gNB, etc.) may or may not be inter-subband CLI. For example, wireless communications system 200 may support fully overlapping full duplex communications (e.g., in which case multiple UEs 115 are performing full duplex communications via the same subbands (e.g., the same uplink subband and the same downlink subbands)). For example, UE 115-a may transmit uplink signaling, while UE 115-b is monitoring for downlink signaling. The uplink signaling transmitted by UE 115-a may result in intra-cell CLI 205-a (e.g., inter-UE, inter-subband CLI), which may impact UE 115-b when attempting to receive downlink signaling from network entity 105-a. Similarly, UE 115-c may transmit uplink signaling to network entity 105-b, which may result in inter-cell interference 205-b (e.g., inter-subband inter-cell inter-UE CLI) for UE 115-b, and intra-cell interference 205-c (e.g., inter-subband intra-cell interference) for UE 115-d.

To mitigate or avoid such CLI 205, wireless communications devices may perform CLI measurements. For instance, network entity 105-a and network entity 105-b may perform CLI measurements for CLI mitigation (e.g., gNB-to-gNB co-channel CLI measurements or channel measurements). Such CLI measurements may be performed based on transparent uplink resource muting techniques (e.g., avoiding scheduling on measurement resources), or may be performed based on non-transparent uplink resource muting techniques (e.g., defining uplink resource muting patterns with one or more resource elements (REs) or resource blocks (RBs) muted). For example, if a wireless device (e.g., network entity 105-b) is attempting to measure CLI 205 (e.g., CLI 205-d), but UE 115-c is transmitting uplink signaling during the CLI measurements, then the CLI measurements may not be accurate, and may therefore result in less effective or ineffective CLI mitigation techniques. Thus, by implementing resource muting as described herein, network entity 105-b may measure gNB-to-gNB CLI levels, channel measurements, CLI interference covariance matrices, etc., with less interference from uplink signaling. In some aspects, uplink muting may be accomplished via uplink rate matching.

As described herein, to support CLI measurement and mitigation, a network entity 105 may configure one or more UEs 115 with rate matching information via a PUSCH configuration. The PUSCH configuration may be transmitted from network entity 105 to UE 115 via radio resource control (RRC) information. The PUSCH configuration may include a parameter that is indicative that the rate matching information is configured for network entity 105 (e.g., for a communication with the network entity 105, such as a PUSCH transmission to the network entity 105). UE 115 may determine from the rate matching information, a frequency-based rate matching pattern associated with a resource muting pattern during which the UE 115 may not transmit uplink signaling. The frequency-based rate matching pattern is based on a comb-2 pattern for both discrete Fourier transform spread orthogonal frequency division multiplexing and cyclic prefix orthogonal frequency division multiplexing. The rate matching information may also indicate one or two uplink symbols associated with the frequency-based rate matching pattern. UE 115 may apply rate matching to the one or two symbols based on the frequency-based rate matching pattern and then transmit a PUSCH transmission in accordance with the frequency-based rate matching pattern.

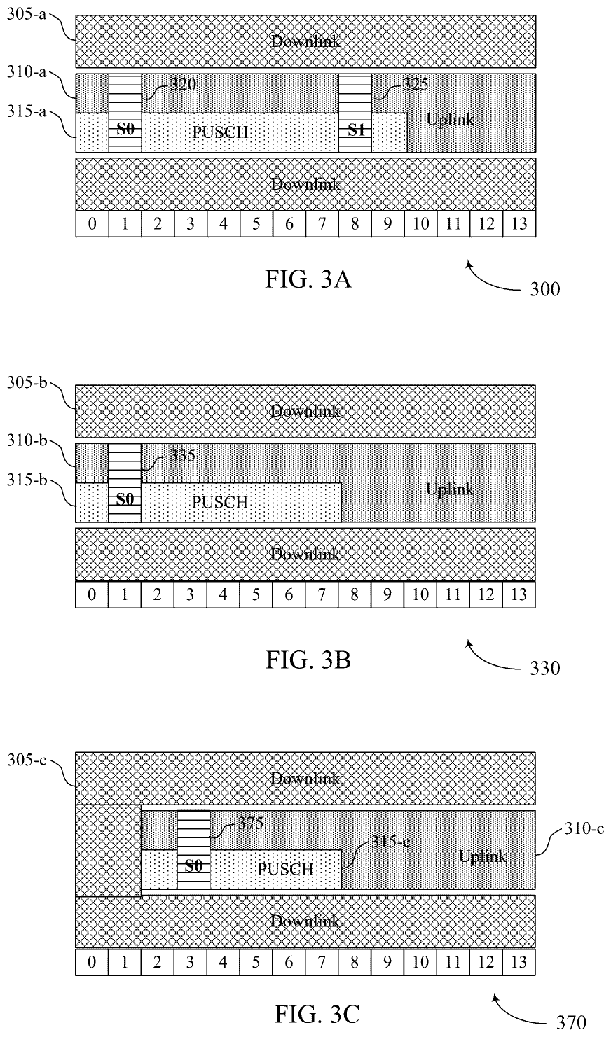

FIGS. 3A, 3B, and 3C show examples of resource diagrams 300, 330, and 370, respectively, that support techniques for RRC configuration of PUSCH and UL muting pattern in SBFD in accordance with one or more aspects of the present disclosure. Resource diagrams 300, 330, and 370 may illustrate time and frequency resource allocations associated with a frequency-based rate matching pattern. Each of resource diagrams 300, 330, and 370 may include downlink resources 305-a, 305-b, and 305-c, respectively, uplink resources 310-a, 310-b, and 310-c, respectively, and PUSCH resources 315-a, 315-b, and 315-c, respectively. Additionally, resource diagrams 300, 330, and 370 may include a plurality of uplink symbols which may represent a slot, and there may be 14 uplink symbols in the slot. In an aspect, a slot may be a transmission structure and the slot may include mixed symbol types (e.g., uplink, downlink, etc.).

A UE may receive rate matching information via a PUSCH configuration from a network entity. The rate matching information may include respective locations for one or two uplink symbols among a plurality of uplink symbols that are to be muted. The one or two uplink symbols that are to be muted and the remaining uplink symbols may be indicated in a bitmap. For example, in resource diagram 300 the bitmap may be 01000000100000, where ‘1’ may indicate the muted symbols in symbols 1 and 8 illustrated by muted symbols 320 and 325, respectively. In an aspect, there may be a threshold quantity of symbols that exist between the first muted uplink symbol and the second muted uplink symbol.

In an aspect, in resource diagram 330 the bitmap may be 01000000100000, where ‘1’ may indicate the muted symbols in symbols 1 and 8. However, the PUSCH resource 315-b in resource diagram 330 may only extend from symbols 0 to 7. Therefore, muted symbol 335 may be the only uplink symbol that is muted due to PUSCH resource 315-b resource not extending to symbol 8.

In an aspect, in resource diagram 370 the bitmap may be 01000000100000, where ‘1’ may indicate the muted symbols in symbols 1 and 8. However, in resource diagram 370, downlink resources 305-c may be allocated for symbols 0 and 1 in the same frequency band of uplink resources 310-c. Therefore, muted symbol 375 may occur in symbol 3 as it is the second uplink symbol of PUSCH resource 315-c (which is allocated from symbols 2 through 7). Muted symbol 375 may be the only symbol that is muted even though the bitmap may indicate two muted symbols due to an absence of an eighth uplink symbol in PUSCH resource 315-c.

In an aspect, a limited set of possible symbol patterns may be available for uplink muting and an RRC configuration message may indicate one of the possible defined patterns. These defined patterns may be defined in a table or an index (e.g., time domain resource allocation table) with each row of the table or index indicating the symbol patterns of the uplink symbols to be muted among the plurality of uplink symbols. An RRC configuration message may indicate to a UE which row of the table or index to utilize indicating the muted uplink symbols. In an aspect, the location of the second muted symbol may be based on the location of the first muted symbol. In an aspect, a second muted uplink symbol may be a predetermined number of symbols offset from the first muted uplink symbol. In an aspect, the rate matching information indicates the offset.

In an aspect, the location of the muted uplink symbols may be determined based on the location of uplink symbols in the slot. For example, a first muted symbol may be an Nth uplink symbol among the plurality of uplink symbols, where N may be an integer greater than or equal to 1. In the example, a second muted symbol may be an Mth uplink symbol among the plurality of uplink symbols, where M may be an integer greater than N. In another aspect, locations of the first and second muted symbols are fixed.

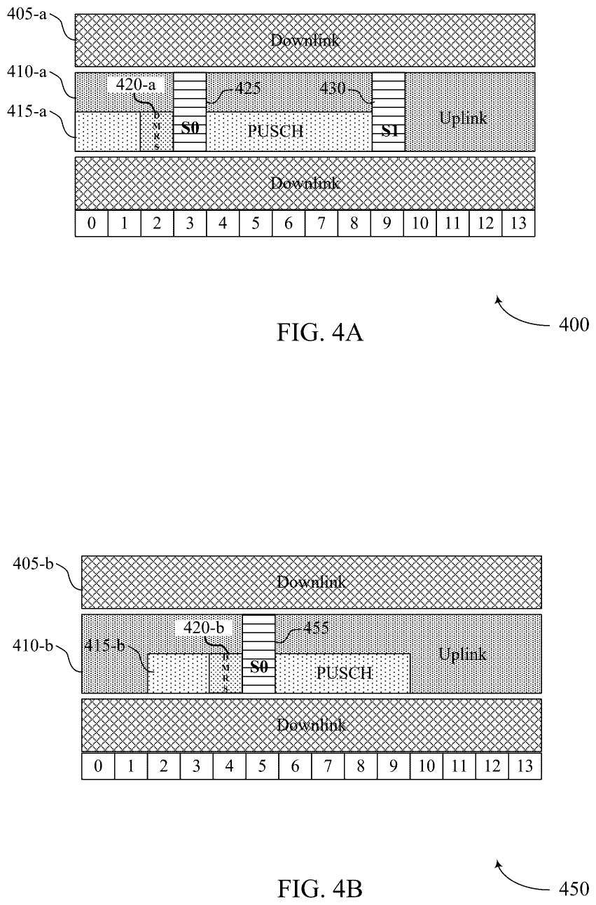

FIGS. 4A and 4B show examples of resource diagrams 400 and 450 that support techniques for RRC configuration of PUSCH and UL muting pattern in SBFD in accordance with one or more aspects of the present disclosure. Resource diagrams 400 and 450 may illustrate time and frequency resource allocations associated with a frequency-based rate matching pattern. Each of resource diagrams 400 and 450 may include downlink resources 405-a and 405-b, respectively, uplink resources 410-a and 410-b, respectively, PUSCH resources 415-a and 415-b, respectively, and demodulation reference signals (DMRSs) 420-a and 420-b, respectively. Additionally, resource diagrams 400 and 450 may include a plurality of uplink symbols which may represent a slot, and there may be 14 uplink symbols in the slot. In an aspect, a slot may be a transmission structure.

A UE may receive rate matching information via a PUSCH configuration from a network entity. The rate matching information may include respective locations for one or two uplink symbols among a plurality of uplink symbols that are to be muted. The respective locations for the one or two uplink symbols to be muted may be based on a PUSCH allocation associated with a PUSCH transmission. In other words, the locations of the muted uplink symbols are indexed based on symbols allocated to the PUSCH allocation and not based on the 14 symbols in a slot.

In an aspect, an index may indicate that the first uplink symbol to be muted is 3 and the second uplink symbol to be muted is 9, or a bitmap indicate these symbols as 00010000010000, where ‘1’ may indicate the muted symbols in symbols 3 and 9. This may be illustrated in resource diagram 400 by muted symbols 425 and 430, respectively.

In an aspect, the locations of muted uplink symbols may be defined with regard to locations of one or more DMRS symbols in a PUSCH allocation. For example, if an index indicates that that the first uplink symbol to be muted is 1, the first uplink symbol to be muted is located in the symbol immediately after a DMRS symbol. This may be illustrated in resource diagram 450 where muted symbol 455 is located in the symbol 5, which is the first symbol after DMRS symbol 420-b which is located in symbol 4. An index for a second uplink symbol to be muted may also be based on a second DMRS symbol in the PUSCH allocation (not pictured).

In an aspect, the locations of muted uplink symbols may be defined with regard to the length of the PUSCH allocation. For example, an index may indicate that the first uplink symbol to be muted is 3 and the second uplink symbol to be muted is 9. This may be illustrated in resource diagram 400 where muted symbol 425 is located at symbol 3. Muted symbol 430 may be located at symbol 9 based on PUSCH resources 415-a (e.g., PUSCH allocation) being 10 symbols long.

In aspect, the locations of muted uplink symbols may be based on PUSCH symbols not carrying a DMRS or a phase tracking reference signal (PTRS). For example, an index may indicate that the first uplink symbol to be muted is 2. Here, the first uplink symbol to be muted is the third symbol in a PUSCH allocation that does not contain either a DMRS or PTRS symbol. This may be illustrated in resource diagram 400 where PUSCH resources 415-a (e.g., PUSCH allocation) contains a DMRS symbol 420-a at symbol position 2. Since the index indicates that the first uplink symbol to be muted is 2 (third symbol), the muted symbol 425 is located at symbol position 3.

In an aspect, the rate matching information may include an index which indicates the locations of uplink symbols to be muted. In some aspects, the index may be a time domain resource allocation table. The index may include information such as a particular PUSCH mapping type, a particular slot location of the PUSCH transmission, a particular starting symbol, a particular length of the PUSCH transmission, and a respective location for each uplink symbol of the one or two uplink symbols. This information may also be located in respective rows of a plurality of rows of the time domain resource allocation table, where each row may a different frequency-based rate matching pattern. In some aspects, the information of the time domain resource allocation table may be configured via an RRC configuration message.

In an aspect, the locations of uplink symbols to be muted may be a function of a start and length indicator value (SLIV), where the SLIV is for a time domain allocation corresponding to the PUSCH configuration information.

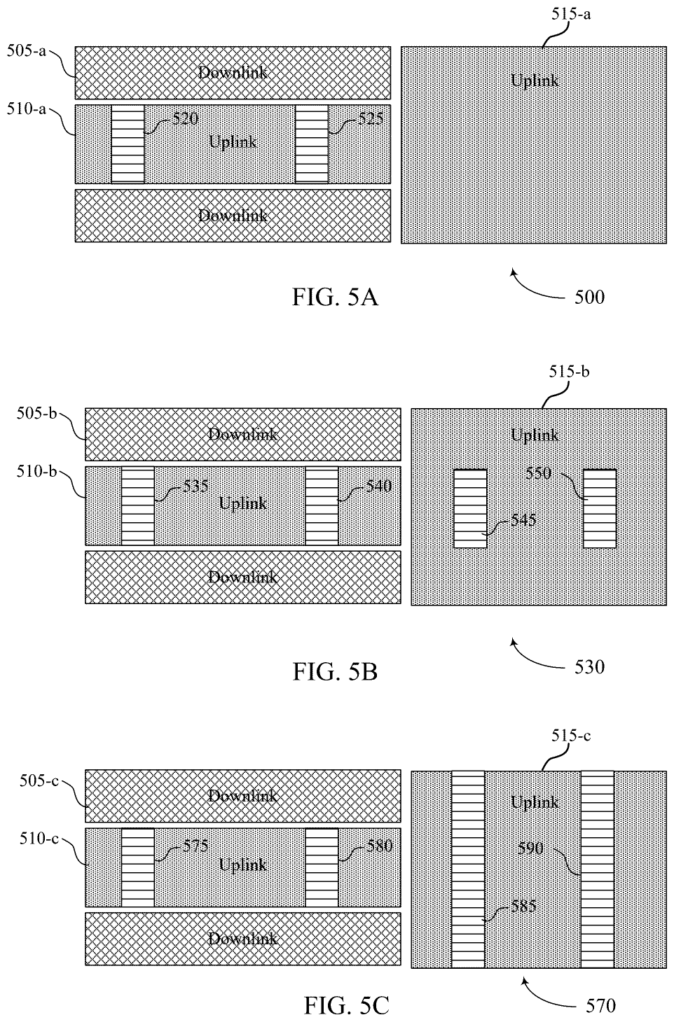

FIGS. 5A, 5B, and 5C show respective examples of resource diagrams 500, 530, and 570 that support techniques for RRC configuration of PUSCH and UL muting pattern in SBFD in accordance with one or more aspects of the present disclosure. Resource diagrams 500, 530, and 570 may illustrate time and frequency resource allocations associated with a frequency-based rate matching pattern. Each of resource diagrams 500, 530, and 570 may include downlink resources 505-a, 505-b, and 505-c in an SBFD slot, respectively, uplink resources 510-a, 510-b, and 510-c in an SBFD slot, respectively, and uplink resources 515-a, 515-b, and 515-c in a non-SBFD slot. Additionally, resource diagrams 500, 530, and 570 may include a plurality of uplink symbols which may represent a slot, and there may be 14 uplink symbols in the slot. In an aspect, a slot may be a transmission structure.

In an aspect, the frequency-based rate matching pattern is configured during only an SBFD slot in which a PUSCH transmission is scheduled. In an aspect, a maximum bandwidth available for the frequency-based rate matching pattern in either an SBFD slot or a non-SBFD slot is an uplink sub-band in the SBFD slot. This may be shown in resource diagram 500 which illustrates that muted uplink symbols only occur in uplink resource 510-a in the SBFD slot (muted uplink symbols 520 and 525), and does not occur in uplink resource 515-a in the non-SBFD slot. Also illustrated in resource diagram 500 is that the maximum bandwidth of muted uplink symbols 520 and 525 is the bandwidth of the uplink sub-band in the SBFD slot.

In an aspect, the frequency-based rate matching pattern is configured for both SBFD and non-SBFD slots. In an aspect, a maximum bandwidth available for the frequency-based rate matching pattern in either an SBFD slot or a non-SBFD slot is an uplink sub-band in the SBFD slot in which the PUSCH transmission is scheduled. This may be shown in resource diagram 530 which illustrates that muted uplink symbols may occur in both uplink resource 510-b in the SBFD slot (muted uplink symbols 535 and 540) and uplink resource 515-b in the non-SBFD slot (muted uplink symbols 545 and 550). Also illustrated in resource diagram 530 is that the maximum bandwidth of muted uplink symbols 535, 540, 545, and 550 is the bandwidth of the uplink sub-band in the SBFD slot.

In an aspect, the frequency-based rate matching pattern is configured for both SBFD and non-SBFD slots. In an aspect, a maximum bandwidth available for the frequency-based rate matching pattern in either an SBFD slot or a non-SBFD slot is an uplink sub-band in a non-SBFD slot in which the PUSCH transmission is scheduled.

This may be shown in resource diagram 570 which illustrates that muted uplink symbols may occur in both uplink resource 510-c in the SBFD slot (muted uplink symbols 575 and 580) and uplink resource 515-c in the non-SBFD slot (muted uplink symbols 585 and 590). Also illustrated in resource diagram 570 is that the maximum bandwidth of the muted uplink symbols (e.g., muted uplink symbols 585 and 590) is the bandwidth of the uplink sub-band in the non-SBFD slot. In an aspect, the maximum bandwidth of the muted uplink symbols may be based on the uplink BWP.

In an aspect, the maximum bandwidth of the muted uplink symbols may be indicated in an RRC configuration message. In an aspect, the maximum bandwidth is at least equal to an uplink sub-band in the SBFD slot.

In an aspect, the frequency-based rate matching pattern may be a comb-2 pattern that is configured with a resource element (RE) offset of 0 or 1. In an aspect, the RE offset may be received in an RRC configuration message. In an aspect, the RE offset is a non-signaled RE offset.

In an aspect, a UE may receive an RRC configuration message which indicates a periodicity and a slot offset associated with the frequency-based rate matching pattern. In an aspect, a UE may receive an RRC configuration message which indicates a time domain pattern associated with the frequency-based rate matching pattern.

In an aspect, a UE may receive an RRC configuration message which includes one or more fields which may include a first field indicative of whether waveform switching is based on the frequency-based rate matching pattern, or a second field indicative of whether PUSCH repetition type-A, PUSCH repetition type-B, transport block processing over multi-slot (TBoMS) PUSCH, or downlink control information (DCI) scheduling multiple PUSCH is based on the frequency-based rate matching pattern.

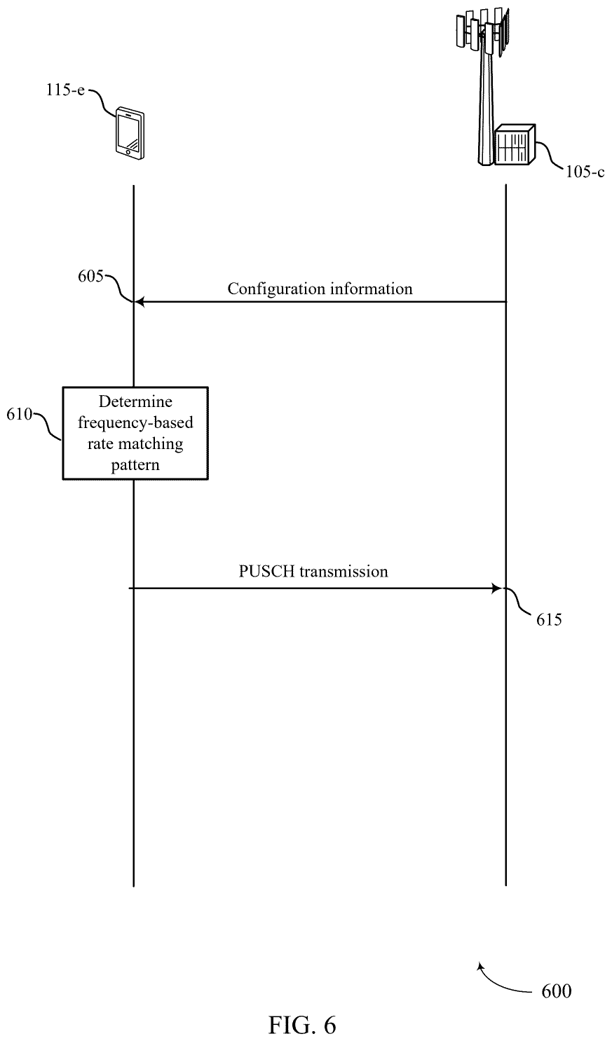

FIG. 6 shows an example of a process flow diagram 600 that supports techniques for RRC configuration of PUSCH and UL muting pattern in SBFD in accordance with one or more aspects of the present disclosure. Process flow diagram 600 may implement, or be implemented by, aspects of wireless communications system 100 or wireless communications system 200. For example, a UE 115-e and a network entity 105-c may communicate according to process flow diagram 600.

At 605, network entity 105-c may transmit, and UE 115-e may receive, a configuration message which may include PUSCH configuration information that includes rate matching information. In some aspects uplink muting may be accomplished via uplink rate matching.

At 610, UE 115-e may determine, based on the rate matching information, a frequency-based rate matching pattern for PUSCH transmissions. The rate matching information may include locations for one or two uplink symbols that are to be muted. UE 115-e may utilize the frequency-based rate matching pattern for the one or two symbols for PUSCH transmissions.

At 615, UE 115-e may transmit, and network entity 105-c may receive, a PUSCH transmission based on the frequency-based rate matching pattern.

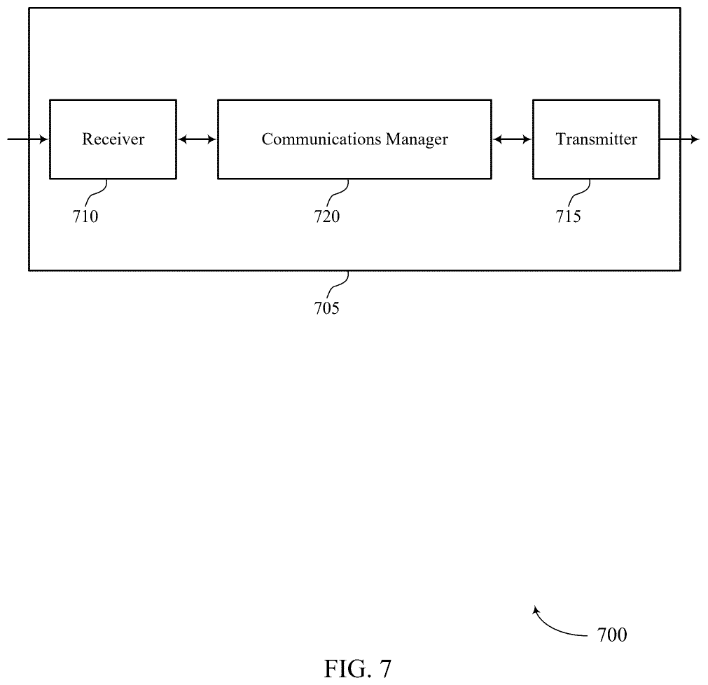

FIG. 7 shows a block diagram 700 of a device 705 that supports techniques for RRC configuration of PUSCH and UL muting pattern in SBFD in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for RRC configuration of PUSCH and UL muting pattern in SBFD). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for RRC configuration of PUSCH and UL muting pattern in SBFD). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of techniques for RRC configuration of PUSCH and UL muting pattern in SBFD as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

For example, the communications manager 720 is capable of, configured to, or operable to support a means for receiving PUSCH configuration information including rate matching information. The communications manager 720 is capable of, configured to, or operable to support a means for determining, based on the rate matching information, a frequency-based rate matching pattern for one or more PUSCH transmissions, where the frequency-based rate matching pattern includes one or two symbols to which rate matching is to be applied. The communications manager 720 is capable of, configured to, or operable to support a means for transmitting a PUSCH transmission based on the frequency-based rate matching pattern.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for uplink muting which may result in CLI mitigation, better channel performance, and increased reliability of wireless signaling.

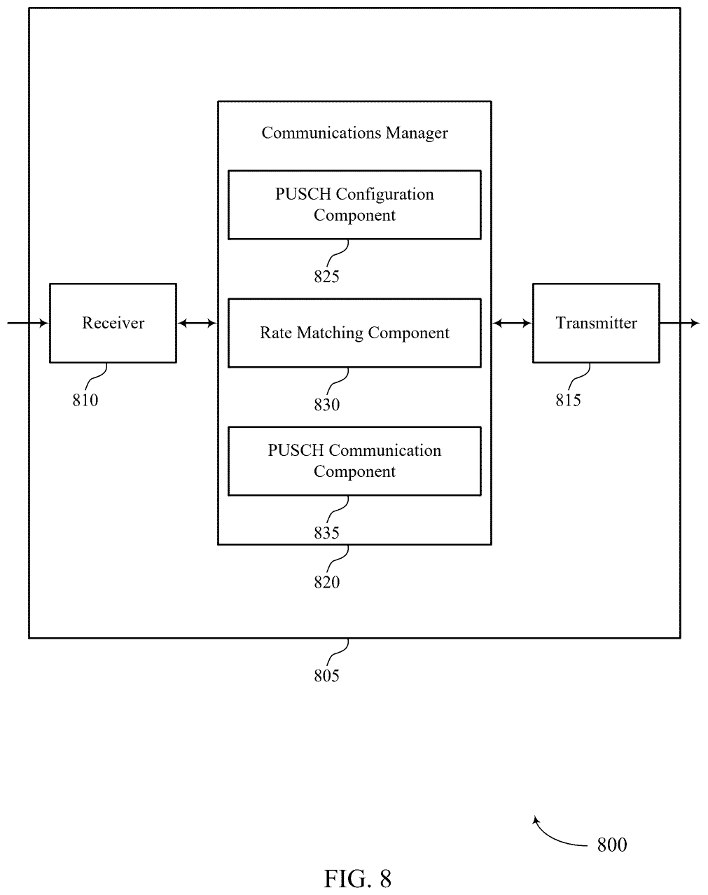

FIG. 8 shows a block diagram 800 of a device 805 that supports techniques for RRC configuration of PUSCH and UL muting pattern in SBFD in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for RRC configuration of PUSCH and UL muting pattern in SBFD). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for RRC configuration of PUSCH and UL muting pattern in SBFD). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for RRC configuration of PUSCH and UL muting pattern in SBFD as described herein. For example, the communications manager 820 may include a PUSCH configuration component 825, a rate matching component 830, a PUSCH communication component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The PUSCH configuration component 825 is capable of, configured to, or operable to support a means for receiving PUSCH configuration information including rate matching information. The rate matching component 830 is capable of, configured to, or operable to support a means for determining, based on the rate matching information, a frequency-based rate matching pattern for one or more PUSCH transmissions, where the frequency-based rate matching pattern includes one or two symbols to which rate matching is to be applied. The PUSCH communication component 835 is capable of, configured to, or operable to support a means for transmitting a PUSCH transmission based on the frequency-based rate matching pattern.

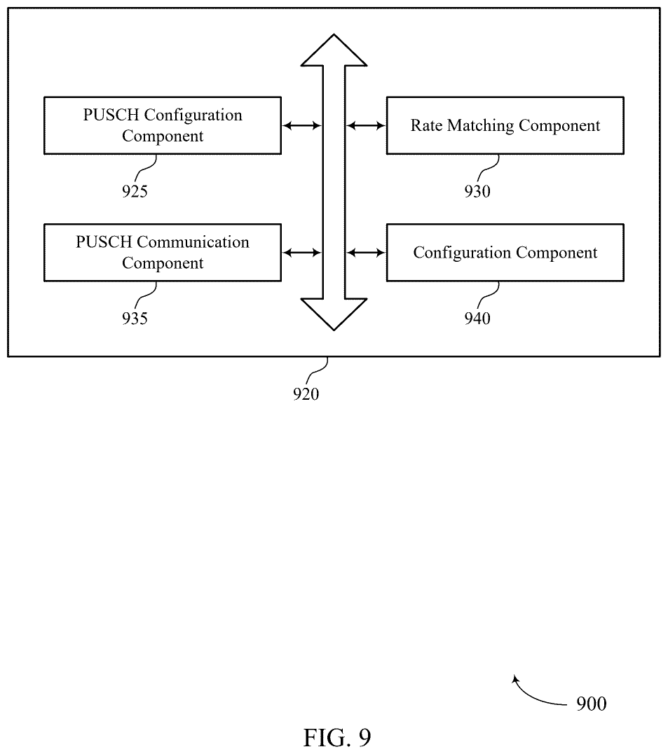

FIG. 9 shows a block diagram 900 of a communications manager 920 that supports techniques for RRC configuration of PUSCH and UL muting pattern in SBFD in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for RRC configuration of PUSCH and UL muting pattern in SBFD as described herein. For example, the communications manager 920 may include a PUSCH configuration component 925, a rate matching component 930, a PUSCH communication component 935, a configuration component 940, or any combination thereof. Each of these components, or components or subcomponents thereof (e.g., one or more processors, one or more memories), may communicate, directly or indirectly, with one another (e.g., via one or more buses).

The PUSCH configuration component 925 is capable of, configured to, or operable to support a means for receiving PUSCH configuration information including rate matching information. The rate matching component 930 is capable of, configured to, or operable to support a means for determining, based on the rate matching information, a frequency-based rate matching pattern for one or more PUSCH transmissions, where the frequency-based rate matching pattern includes one or two symbols to which rate matching is to be applied. The PUSCH communication component 935 is capable of, configured to, or operable to support a means for transmitting a PUSCH transmission based on the frequency-based rate matching pattern.

In some examples, the PUSCH configuration information includes a parameter indicative that the rate matching information is configured for the network entity.

In some examples, the rate matching information is indicative of one or two uplink symbols associated with the frequency-based rate matching pattern.

In some examples, the rate matching information includes a respective location for each uplink symbol of the one or two uplink symbols among a set of multiple uplink symbols.

In some examples, locations for each uplink symbol of the set of multiple uplink symbols are indicated in a bitmap. In some examples, the set of multiple uplink symbols in a slot are in accordance with the bitmap.

In some examples, the set of multiple uplink symbols represents a slot.

In some examples, the set of multiple uplink symbols includes 14 symbols.

In some examples, the one or two uplink symbols include a first uplink symbol and a second uplink symbol. In some examples, a threshold quantity of symbols exist between the first uplink symbol and the second uplink symbol.

In some examples, the respective location for the first uplink symbol is a first location and the respective location for the second uplink symbol is a second location.

In some examples, the one or two uplink symbols include a first uplink symbol. In some examples, the rate matching information includes a location of the first uplink symbol among a first subset of two or more uplink symbols of a set of multiple uplink symbols.

In some examples, the one or two uplink symbols includes a first uplink symbol and a second uplink symbol. In some examples, the location of the first uplink symbol and a location of the second uplink symbol are indicated by an index included in the rate matching information. In some examples, the index is associated with a symbol pattern.

In some examples, the set of multiple uplink symbols represents a slot.

In some examples, the set of multiple uplink symbols includes 14 symbols.

In some examples, the one or two uplink symbols include a second uplink symbol. In some examples, a second location of the second uplink symbol among the set of multiple uplink symbols is based on the location of the first uplink symbol.

In some examples, the one or two uplink symbols include a second uplink symbol. In some examples, a second location of the second uplink symbol among the set of multiple uplink symbols is based on an offset from the location of the first uplink symbol.

In some examples, the rate matching information includes the offset.

In some examples, the set of multiple uplink symbols represents a slot.

In some examples, the set of multiple uplink symbols includes 14 symbols.

In some examples, the one or two uplink symbols is based on relative locations of uplink symbols in a slot.

In some examples, the one or two uplink symbols include a first uplink symbol. In some examples, a location of first uplink symbol among a set of multiple uplink symbols is an Nth uplink symbol among the set of multiple uplink symbols. In some examples, N is an integer greater than or equal to 1.

In some examples, the set of multiple uplink symbols represents a slot.

In some examples, the set of multiple uplink symbols includes 14 symbols.

In some examples, the one or two uplink symbols include a second uplink symbol. In some examples, a location of second uplink symbol among a set of multiple uplink symbols is an Mth uplink symbol among the set of multiple uplink symbols. In some examples, M is an integer greater than N.

In some examples, the set of multiple uplink symbols represents a slot.

In some examples, the set of multiple uplink symbols includes 14 symbols.

In some examples, the one or two uplink symbols includes a first uplink symbol and a second uplink symbol. In some examples, locations of the first uplink symbol and the second uplink symbol are fixed.

In some examples, the rate matching information includes a respective location for each uplink symbol of the one or two uplink symbols among a set of multiple uplink symbols. In some examples, the respective location for each uplink symbol of the one or two uplink symbols is based on a PUSCH allocation associated with the PUSCH transmission.

In some examples, the set of multiple uplink symbols represents a slot.

In some examples, the set of multiple uplink symbols includes 14 symbols.

In some examples, the one or two uplink symbols includes a first uplink symbol and a second uplink symbol. In some examples, locations of the first uplink symbol and the second uplink symbol are defined via respective location parameters included in the rate matching information. In some examples, the respective location parameters indicate the locations of the first uplink symbol and the second uplink symbol based on demodulation reference signal position within a PUSCH allocation associated with the PUSCH transmission.

In some examples, the one or two uplink symbols includes a first uplink symbol and a second uplink symbol. In some examples, locations of the first uplink symbol and the second uplink symbol are defined via respective location parameters included in the rate matching information. In some examples, the respective location parameters indicate the locations of the first uplink symbol and the second uplink symbol based on a length of a PUSCH allocation associated with the PUSCH transmission.

In some examples, the one or two uplink symbols includes a first uplink symbol and a second uplink symbol. In some examples, locations of the first uplink symbol and the second uplink symbol are defined via respective location parameters included in the rate matching information. In some examples, the respective location parameters indicate the locations of the first uplink symbol and the second uplink symbol based on positions of symbols that do not include a demodulation reference signal or a phase tracking reference signal within a PUSCH allocation associated with the PUSCH transmission.

In some examples, the rate matching information includes an index. In some examples, a respective location for each uplink symbol of the one or two uplink symbols is based on the index. In some examples, the index corresponds to a row of a time domain resource allocation table.

In some examples, rate matching information includes an index corresponding to particular information. In some examples, the particular information includes a particular PUSCH mapping type, a particular slot location of the PUSCH transmission, a particular starting symbol, a particular length of the PUSCH transmission, and a respective location for each uplink symbol of the one or two uplink symbols.

In some examples, the index corresponds to a row of a time domain resource allocation table that includes the particular information.

In some examples, a respective location for each uplink symbol the one or two uplink symbols is based on a start and length indicator value.

In some examples, the start and length indicator value is for a time domain allocation corresponding to the PUSCH configuration information.

In some examples, the frequency-based rate matching pattern is configured during only a sub-band full-duplex (SBFD) slot in which the PUSCH transmission is scheduled.

In some examples, a maximum bandwidth available for the frequency-based rate matching pattern is an uplink sub-band in the SBFD slot.

In some examples, the frequency-based rate matching pattern is configured during either a sub-band full-duplex (SBFD) slot or a non-SBFD slot in which the PUSCH transmission is scheduled.

In some examples, a maximum bandwidth available for the frequency-based rate matching pattern in either the SBFD slot or the non-SBFD slot is an uplink sub-band in the SBFD slot.

In some examples, a maximum bandwidth available for the frequency-based rate matching pattern is based on an uplink sub-band in an SBFD slot in which the PUSCH transmission is scheduled, or an uplink sub-band in a non-SBFD slot in which the PUSCH transmission is scheduled.

In some examples, the rate matching component 930 is capable of, configured to, or operable to support a means for receiving information indicative of a maximum bandwidth available for the frequency-based rate matching pattern in either the SBFD slot or the non-SBFD slot, where the maximum bandwidth is at least equal to an uplink sub-band in the SBFD slot.

In some examples, the frequency-based rate matching pattern is a comb-2 pattern that is configured with a resource element (RE) offset.

In some examples, the configuration component 940 is capable of, configured to, or operable to support a means for receiving the RE offset via a configuration message.

In some examples, the RE offset is a non-signaled RE offset.

In some examples, the configuration component 940 is capable of, configured to, or operable to support a means for receiving a configuration message including a periodicity and a slot offset associated with the frequency-based rate matching pattern.

In some examples, the configuration component 940 is capable of, configured to, or operable to support a means for receiving a configuration message including a time domain pattern associated with the frequency-based rate matching pattern.

In some examples, the frequency-based rate matching pattern is based on one or more fields. In some examples, the one or more fields include a first field indicative of whether waveform switching is based on the frequency-based rate matching pattern, or a second field indicative of whether PUSCH repetition type-A, PUSCH repetition type-B, transport block processing over multi-slot (TBoMS) PUSCH, or DCI scheduling multiple PUSCH is based on the frequency-based rate matching pattern.

In some examples, the rate matching component 930 is capable of, configured to, or operable to support a means for applying rate matching to the one or two symbols based on the frequency-based rate matching pattern.

In some examples, the frequency-based rate matching pattern is based on a comb-2 pattern for both discrete Fourier transform spread orthogonal frequency division multiplexing and cyclic prefix orthogonal frequency division multiplexing.

In some examples, the configuration component 940 is capable of, configured to, or operable to support a means for receiving RRC information, where the RRC information includes the PUSCH configuration information.

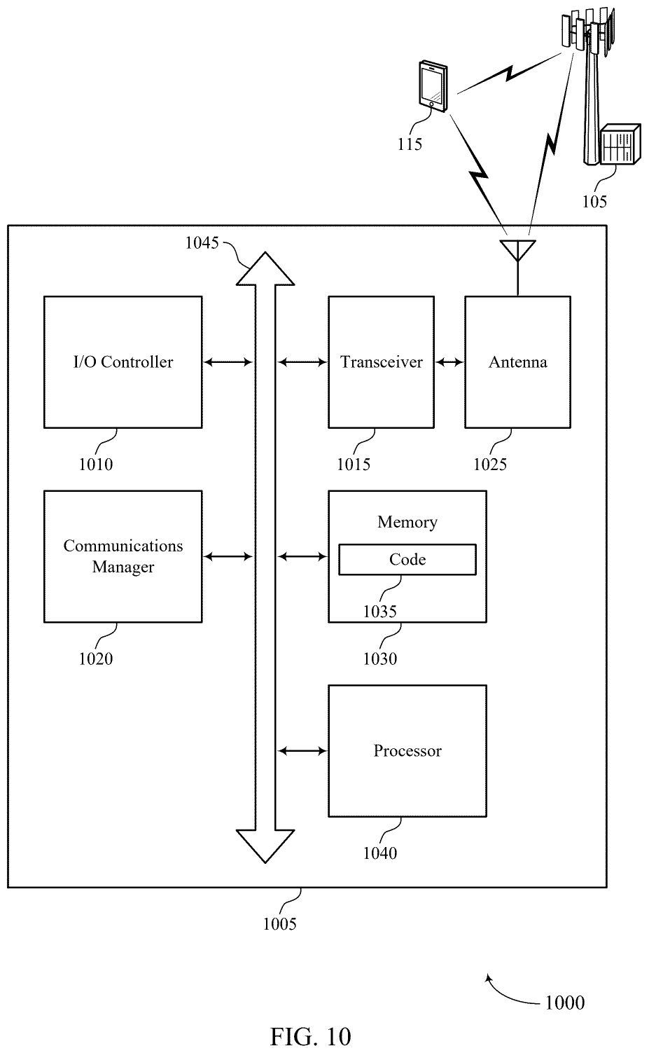

FIG. 10 shows a diagram of a system 1000 including a device 1005 that supports techniques for RRC configuration of PUSCH and UL muting pattern in SBFD in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting techniques for RRC configuration of PUSCH and UL muting pattern in SBFD). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

For example, the communications manager 1020 is capable of, configured to, or operable to support a means for receiving PUSCH configuration information including rate matching information. The communications manager 1020 is capable of, configured to, or operable to support a means for determining, based on the rate matching information, a frequency-based rate matching pattern for one or more PUSCH transmissions, where the frequency-based rate matching pattern includes one or two symbols to which rate matching is to be applied. The communications manager 1020 is capable of, configured to, or operable to support a means for transmitting a PUSCH transmission based on the frequency-based rate matching pattern.

By including or configuring the communications manager 1020 in accordance with examples as described herein, the device 1005 may support techniques for uplink muting which may result in CLI mitigation, better channel performance, and increased reliability of wireless signaling.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of techniques for RRC configuration of PUSCH and UL muting pattern in SBFD as described herein, or the at least one processor 1040 and the at least one memory 1030 may be otherwise configured to, individually or collectively, perform or support such operations.

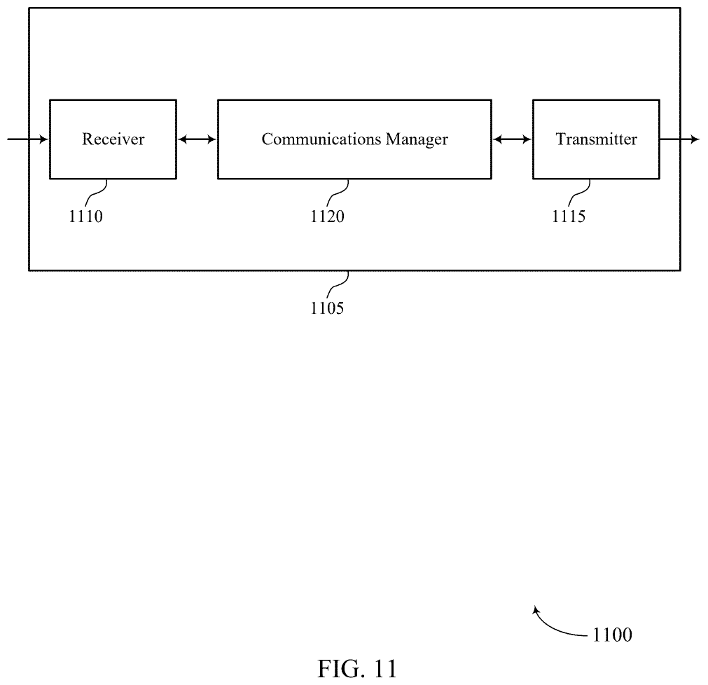

FIG. 11 shows a block diagram 1100 of a device 1105 that supports techniques for RRC configuration of PUSCH and UL muting pattern in SBFD in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of techniques for RRC configuration of PUSCH and UL muting pattern in SBFD as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

For example, the communications manager 1120 is capable of, configured to, or operable to support a means for transmitting PUSCH configuration information including rate matching information. The communications manager 1120 is capable of, configured to, or operable to support a means for receiving a PUSCH transmission based on a frequency-based rate matching pattern for one or more PUSCH transmissions, where the frequency-based rate matching pattern includes one or two symbols to which rate matching is to be applied.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for uplink muting which may result in CLI mitigation, better channel performance, and increased reliability of wireless signaling.

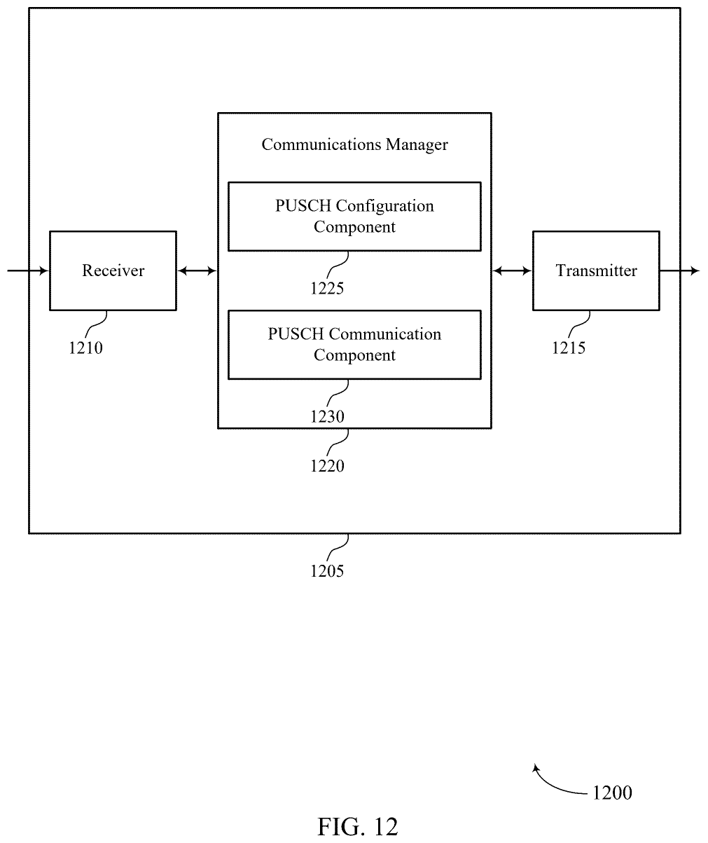

FIG. 12 shows a block diagram 1200 of a device 1205 that supports techniques for RRC configuration of PUSCH and UL muting pattern in SBFD in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of techniques for RRC configuration of PUSCH and UL muting pattern in SBFD as described herein. For example, the communications manager 1220 may include a PUSCH configuration component 1225, a PUSCH communication component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The PUSCH configuration component 1225 is capable of, configured to, or operable to support a means for transmitting PUSCH configuration information including rate matching information. The PUSCH communication component 1230 is capable of, configured to, or operable to support a means for receiving a PUSCH transmission based on a frequency-based rate matching pattern for one or more PUSCH transmissions, where the frequency-based rate matching pattern includes one or two symbols to which rate matching is to be applied.

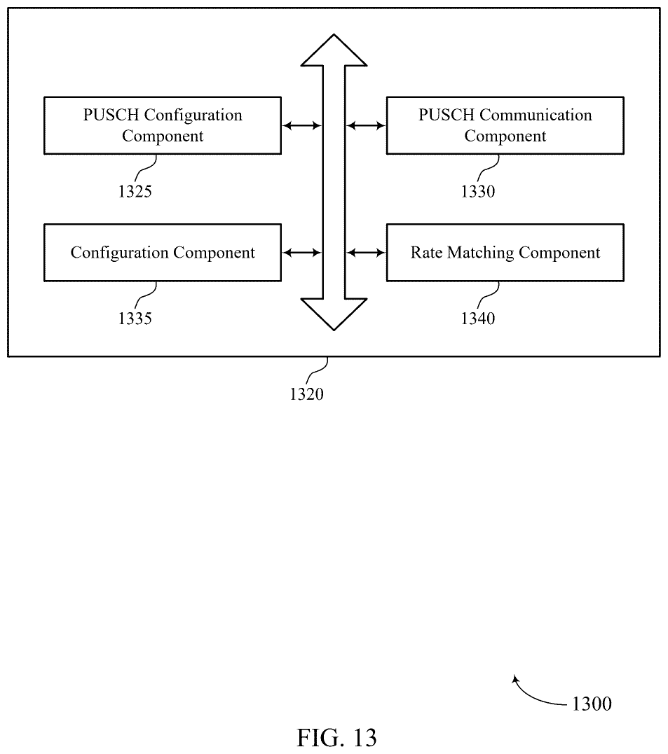

FIG. 13 shows a block diagram 1300 of a communications manager 1320 that supports techniques for RRC configuration of PUSCH and UL muting pattern in SBFD in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of techniques for RRC configuration of PUSCH and UL muting pattern in SBFD as described herein. For example, the communications manager 1320 may include a PUSCH configuration component 1325, a PUSCH communication component 1330, a configuration component 1335, a rate matching component 1340, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The PUSCH configuration component 1325 is capable of, configured to, or operable to support a means for transmitting PUSCH configuration information including rate matching information. The PUSCH communication component 1330 is capable of, configured to, or operable to support a means for receiving a PUSCH transmission based on a frequency-based rate matching pattern for one or more PUSCH transmissions, where the frequency-based rate matching pattern includes one or two symbols to which rate matching is to be applied.

In some examples, the PUSCH configuration information includes a parameter indicative that the rate matching information is configured for a second network entity.

In some examples, the rate matching information is indicative of one or two uplink symbols associated with the frequency-based rate matching pattern.

In some examples, the rate matching information includes a respective location for each uplink symbol of the one or two uplink symbols among a set of multiple uplink symbols.

In some examples, locations for each uplink symbol of the set of multiple uplink symbols are indicated in a bitmap. In some examples, the set of multiple uplink symbols in a slot are in accordance with the bitmap.

In some examples, the set of multiple uplink symbols represents a slot.

In some examples, the set of multiple uplink symbols includes 14 symbols.

In some examples, the one or two uplink symbols include a first uplink symbol and a second uplink symbol. In some examples, a threshold quantity of symbols exist between the first uplink symbol and the second uplink symbol.

In some examples, the respective location for the first uplink symbol is a first location and the respective location for the second uplink symbol is a second location.

In some examples, the one or two uplink symbols include a first uplink symbol. In some examples, the rate matching information includes a location of the first uplink symbol among a first subset of two or more uplink symbols of a set of multiple uplink symbols.

In some examples, the one or two uplink symbols includes a first uplink symbol and a second uplink symbol. In some examples, the location of the first uplink symbol and a location of the second uplink symbol are indicated by an index included in the rate matching information. In some examples, the index is associated with a symbol pattern.

In some examples, the set of multiple uplink symbols represents a slot.

In some examples, the set of multiple uplink symbols includes 14 symbols.

In some examples, the one or two uplink symbols include a second uplink symbol. In some examples, a second location of the second uplink symbol among the set of multiple uplink symbols is based on the location of the first uplink symbol.

In some examples, the one or two uplink symbols include a second uplink symbol. In some examples, a second location of the second uplink symbol among the set of multiple uplink symbols is based on an offset from the location of the first uplink symbol.

In some examples, the rate matching information includes the offset.

In some examples, the set of multiple uplink symbols represents a slot.

In some examples, the set of multiple uplink symbols includes 14 symbols.

In some examples, the one or two uplink symbols is based on relative locations of uplink symbols in a slot.

In some examples, the one or two uplink symbols include a first uplink symbol. In some examples, a location of first uplink symbol among a set of multiple uplink symbols is an Nth uplink symbol among the set of multiple uplink symbols. In some examples, N is an integer greater than or equal to 1.

In some examples, the set of multiple uplink symbols represents a slot.

In some examples, the one or two uplink symbols include a second uplink symbol. In some examples, a location of second uplink symbol among a set of multiple uplink symbols is an Mth uplink symbol among the set of multiple uplink symbols. In some examples, M is an integer greater than N.

In some examples, the set of multiple uplink symbols represents a slot.

In some examples, the set of multiple uplink symbols includes 14 symbols.

In some examples, the one or two uplink symbols includes a first uplink symbol and a second uplink symbol. In some examples, locations of the first uplink symbol and the second uplink symbol are fixed.

In some examples, the rate matching information includes a respective location for each uplink symbol of the one or two uplink symbols among a set of multiple uplink symbols. In some examples, the respective location for each uplink symbol of the one or two uplink symbols is based on a PUSCH allocation associated with the PUSCH transmission.

In some examples, the set of multiple uplink symbols represents a slot.

In some examples, the set of multiple uplink symbols includes 14 symbols.

In some examples, the one or two uplink symbols includes a first uplink symbol and a second uplink symbol. In some examples, locations of the first uplink symbol and the second uplink symbol are defined via respective location parameters included in the rate matching information. In some examples, the respective location parameters indicate the locations of the first uplink symbol and the second uplink symbol based on demodulation reference signal position within a PUSCH allocation associated with the PUSCH transmission.

In some examples, the one or two uplink symbols includes a first uplink symbol and a second uplink symbol. In some examples, locations of the first uplink symbol and the second uplink symbol are defined via respective location parameters included in the rate matching information. In some examples, the respective location parameters indicate the locations of the first uplink symbol and the second uplink symbol based on a length of a PUSCH allocation associated with the PUSCH transmission.

In some examples, the one or two uplink symbols includes a first uplink symbol and a second uplink symbol. In some examples, locations of the first uplink symbol and the second uplink symbol are defined via respective location parameters included in the rate matching information. In some examples, the respective location parameters indicate the locations of the first uplink symbol and the second uplink symbol based on positions of symbols that do not include a demodulation reference signal or a phase tracking reference signal within a PUSCH allocation associated with the PUSCH transmission.

In some examples, the rate matching information includes an index. In some examples, a respective location for each uplink symbol of the one or two uplink symbols is based on the index. In some examples, the index corresponds to a row of a time domain resource allocation table.

In some examples, rate matching information includes an index corresponding to particular information. In some examples, the particular information includes a particular PUSCH mapping type, a particular slot location of the PUSCH transmission, a particular starting symbol, a particular length of the PUSCH transmission, and a respective location for each uplink symbol of the one or two uplink symbols.

In some examples, the index corresponds to a row of a time domain resource allocation table that includes the particular information.

In some examples, a respective location for each uplink symbol the one or two uplink symbols is based on a start and length indicator value.

In some examples, the start and length indicator value is for a time domain allocation corresponding to the PUSCH configuration information.

In some examples, the frequency-based rate matching pattern is configured during only a sub-band full-duplex (SBFD) slot in which the PUSCH transmission is scheduled.

In some examples, a maximum bandwidth available for the frequency-based rate matching pattern is an uplink sub-band in the SBFD slot.

In some examples, the frequency-based rate matching pattern is configured during either a sub-band full-duplex (SBFD) slot or a non-SBFD slot in which the PUSCH transmission is scheduled.

In some examples, a maximum bandwidth available for the frequency-based rate matching pattern in either the SBFD slot or the non-SBFD slot is an uplink sub-band in the SBFD slot.

In some examples, a maximum bandwidth available for the frequency-based rate matching pattern is based on an uplink sub-band in an SBFD slot in which the PUSCH transmission is scheduled, or an uplink sub-band in a non-SBFD slot in which the PUSCH transmission is scheduled.

In some examples, the rate matching component 1340 is capable of, configured to, or operable to support a means for transmitting information indicative of a maximum bandwidth available for the frequency-based rate matching pattern in either the SBFD slot or the non-SBFD slot, where the maximum bandwidth is at least equal to an uplink sub-band in the SBFD slot.

In some examples, the frequency-based rate matching pattern is a comb-2 pattern that is configured with a resource element (RE) offset.

In some examples, the configuration component 1335 is capable of, configured to, or operable to support a means for transmitting the RE offset via a configuration message.

In some examples, the RE offset is a non-signaled RE offset.

In some examples, the configuration component 1335 is capable of, configured to, or operable to support a means for transmitting a configuration message including a periodicity and a slot offset associated with the frequency-based rate matching pattern.

In some examples, the configuration component 1335 is capable of, configured to, or operable to support a means for transmitting a configuration message including a time domain pattern associated with the frequency-based rate matching pattern.

In some examples, the frequency-based rate matching pattern is based on one or more fields. In some examples, the one or more fields include a first field indicative of whether waveform switching is based on the frequency-based rate matching pattern, or a second field indicative of whether PUSCH repetition type-A, PUSCH repetition type-B, transport block processing over multi-slot (TBoMS) PUSCH, or DCI scheduling multiple PUSCH is based on the frequency-based rate matching pattern.

In some examples, the PUSCH transmission is in accordance with rate matching to the one or two symbols based on the frequency-based rate matching pattern.

In some examples, the frequency-based rate matching pattern is based on a comb-2 pattern for both discrete Fourier transform spread orthogonal frequency division multiplexing and cyclic prefix orthogonal frequency division multiplexing.

In some examples, the configuration component 1335 is capable of, configured to, or operable to support a means for transmitting RRC information, where the RRC information includes the PUSCH configuration information.

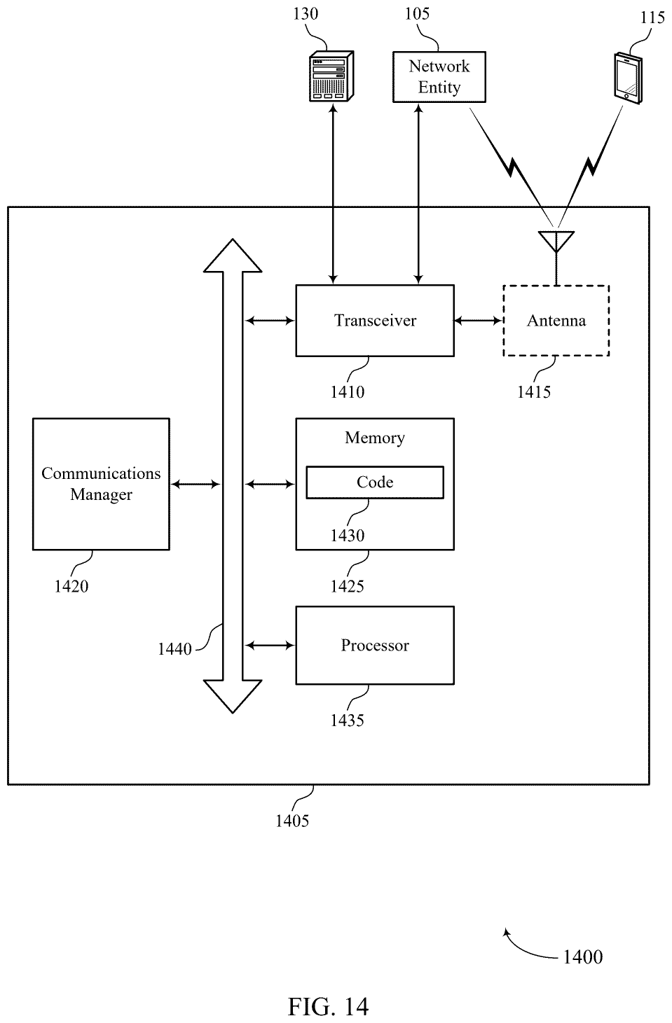

FIG. 14 shows a diagram of a system 1400 including a device 1405 that supports techniques for RRC configuration of PUSCH and UL muting pattern in SBFD in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting techniques for RRC configuration of PUSCH and UL muting pattern in SBFD). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

For example, the communications manager 1420 is capable of, configured to, or operable to support a means for transmitting PUSCH configuration information including rate matching information. The communications manager 1420 is capable of, configured to, or operable to support a means for receiving a PUSCH transmission based on a frequency-based rate matching pattern for one or more PUSCH transmissions, where the frequency-based rate matching pattern includes one or two symbols to which rate matching is to be applied.

By including or configuring the communications manager 1420 in accordance with examples as described herein, the device 1405 may support techniques for uplink muting which may result in CLI mitigation, better channel performance, and increased reliability of wireless signaling.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of techniques for RRC configuration of PUSCH and UL muting pattern in SBFD as described herein, or the at least one processor 1435 and the at least one memory 1425 may be otherwise configured to, individually or collectively, perform or support such operations.

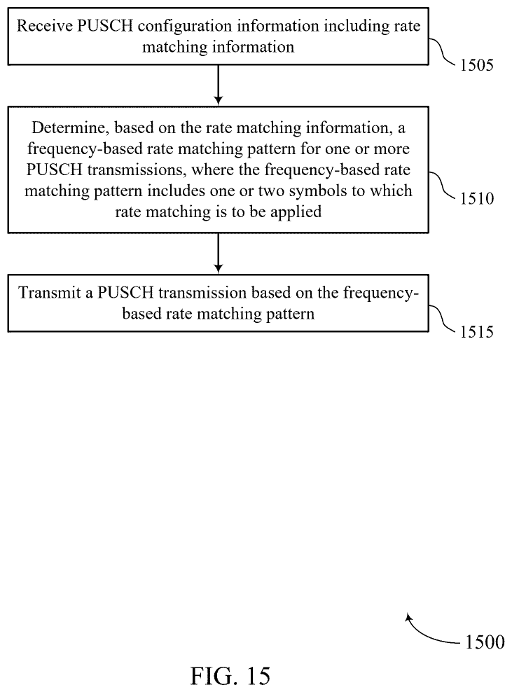

FIG. 15 shows a flowchart illustrating a method 1500 that supports techniques for RRC configuration of PUSCH and UL muting pattern in SBFD in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving PUSCH configuration information including rate matching information. The operations of 1505 may be performed in accordance with examples as disclosed herein. In some examples, aspects of the operations of 1505 may be performed by a PUSCH configuration component 925 as described with reference to FIG. 9.

At 1510, the method may include determining, based on the rate matching information, a frequency-based rate matching pattern for one or more PUSCH transmissions, where the frequency-based rate matching pattern includes one or two symbols to which rate matching is to be applied. The operations of 1510 may be performed in accordance with examples as disclosed herein. In some examples, aspects of the operations of 1510 may be performed by a rate matching component 930 as described with reference to FIG. 9.

At 1515, the method may include transmitting a PUSCH transmission based on the frequency-based rate matching pattern. The operations of 1515 may be performed in accordance with examples as disclosed herein. In some examples, aspects of the operations of 1515 may be performed by a PUSCH communication component 935 as described with reference to FIG. 9.

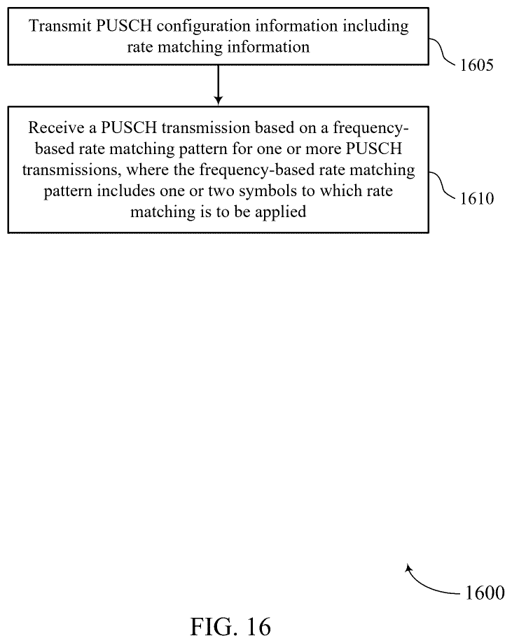

FIG. 16 shows a flowchart illustrating a method 1600 that supports techniques for RRC configuration of PUSCH and UL muting pattern in SBFD in accordance with one or more aspects of the present disclosure. The operations of the method 1600 may be implemented by a network entity or its components as described herein. For example, the operations of the method 1600 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1605, the method may include transmitting PUSCH configuration information including rate matching information. The operations of 1605 may be performed in accordance with examples as disclosed herein. In some examples, aspects of the operations of 1605 may be performed by a PUSCH configuration component 1325 as described with reference to FIG. 13.

At 1610, the method may include receiving a PUSCH transmission based on a frequency-based rate matching pattern for one or more PUSCH transmissions, where the frequency-based rate matching pattern includes one or two symbols to which rate matching is to be applied. The operations of 1610 may be performed in accordance with examples as disclosed herein. In some examples, aspects of the operations of 1610 may be performed by a PUSCH communication component 1330 as described with reference to FIG. 13.

The following provides an overview of aspects of the present disclosure:

Aspect 1: A method of wireless communication performed by a network entity, comprising: receiving PUSCH configuration information including rate matching information; determining, based on the rate matching information, a frequency-based rate matching pattern for one or more PUSCH transmissions, wherein the frequency-based rate matching pattern includes one or two symbols to which rate matching is to be applied; and transmitting a PUSCH transmission based on the frequency-based rate matching pattern.

Aspect 2: The method of aspect 1, wherein the PUSCH configuration information includes a parameter indicative that the rate matching information is configured for the network entity.

Aspect 3: The method of any of aspects 1 through 2, wherein the rate matching information is indicative of one or two uplink symbols associated with the frequency-based rate matching pattern.

Aspect 4: The method of aspect 3, wherein the rate matching information includes a respective location for each uplink symbol of the one or two uplink symbols among a plurality of uplink symbols.

Aspect 5: The method of aspect 4, wherein locations for each uplink symbol of the plurality of uplink symbols are indicated in a bitmap, the plurality of uplink symbols in a slot are in accordance with the bitmap.

Aspect 6: The method of any of aspects 4 through 5, wherein the plurality of uplink symbols represents a slot.

Aspect 7: The method of aspect 6, wherein the plurality of uplink symbols includes 14 symbols.

Aspect 8: The method of any of aspects 4 through 7, wherein the one or two uplink symbols include a first uplink symbol and a second uplink symbol, and a threshold quantity of symbols exist between the first uplink symbol and the second uplink symbol.

Aspect 9: The method of aspect 8, wherein the respective location for the first uplink symbol is a first location and the respective location for the second uplink symbol is a second location.

Aspect 10: The method of any of aspects 3 through 9, wherein the one or two uplink symbols include a first uplink symbol, the rate matching information includes a location of the first uplink symbol among a first subset of two or more uplink symbols of a plurality of uplink symbols.

Aspect 11: The method of aspect 10, wherein the one or two uplink symbols includes a first uplink symbol and a second uplink symbol, the location of the first uplink symbol and a location of the second uplink symbol are indicated by an index included in the rate matching information, the index is associated with a symbol pattern.

Aspect 12: The method of any of aspects 10 through 11, wherein the plurality of uplink symbols represents a slot.

Aspect 13: The method of aspect 12, wherein the plurality of uplink symbols includes 14 symbols.

Aspect 14: The method of any of aspects 10 through 13, wherein the one or two uplink symbols include a second uplink symbol, and a second location of the second uplink symbol among the plurality of uplink symbols is based on the location of the first uplink symbol.

Aspect 15: The method of any of aspects 10 through 14, wherein the one or two uplink symbols include a second uplink symbol, and a second location of the second uplink symbol among the plurality of uplink symbols is based on an offset from the location of the first uplink symbol.

Aspect 16: The method of aspect 15, wherein the rate matching information includes the offset.

Aspect 17: The method of any of aspects 15 through 16, wherein the plurality of uplink symbols represents a slot.

Aspect 18: The method of aspect 17, wherein the plurality of uplink symbols includes 14 symbols.

Aspect 19: The method of any of aspects 3 through 18, wherein the one or two uplink symbols is based on relative locations of uplink symbols in a slot.

Aspect 20: The method of any of aspects 3 through 19, wherein the one or two uplink symbols include a first uplink symbol, a location of first uplink symbol among a plurality of uplink symbols is an Nth uplink symbol among the plurality of uplink symbols, and N is an integer greater than or equal to 1.

Aspect 21: The method of aspect 20, wherein the plurality of uplink symbols represents a slot.

Aspect 22: The method of aspect 21, wherein the plurality of uplink symbols includes 14 symbols.

Aspect 23: The method of any of aspects 3 through 22, wherein the one or two uplink symbols include a second uplink symbol, a location of second uplink symbol among a plurality of uplink symbols is an Mth uplink symbol among the plurality of uplink symbols, and M is an integer greater than N.

Aspect 24: The method of aspect 23, wherein the plurality of uplink symbols represents a slot.

Aspect 25: The method of aspect 24, wherein the plurality of uplink symbols includes 14 symbols.

Aspect 26: The method of any of aspects 3 through 25, wherein the one or two uplink symbols includes a first uplink symbol and a second uplink symbol, locations of the first uplink symbol and the second uplink symbol are fixed.

Aspect 27: The method of any of aspects 3 through 26, wherein the rate matching information includes a respective location for each uplink symbol of the one or two uplink symbols among a plurality of uplink symbols, the respective location for each uplink symbol of the one or two uplink symbols is based on a PUSCH allocation associated with the PUSCH transmission.

Aspect 28: The method of aspect 27, wherein the plurality of uplink symbols represents a slot.

Aspect 29: The method of aspect 28, wherein the plurality of uplink symbols includes 14 symbols.

Aspect 30: The method of any of aspects 27 through 29, wherein the one or two uplink symbols includes a first uplink symbol and a second uplink symbol, locations of the first uplink symbol and the second uplink symbol are defined via respective location parameters included in the rate matching information, the respective location parameters indicate the locations of the first uplink symbol and the second uplink symbol based on demodulation reference signal position within a PUSCH allocation associated with the PUSCH transmission.

Aspect 31: The method of any of aspects 27 through 30, wherein the one or two uplink symbols includes a first uplink symbol and a second uplink symbol, locations of the first uplink symbol and the second uplink symbol are defined via respective location parameters included in the rate matching information, the respective location parameters indicate the locations of the first uplink symbol and the second uplink symbol are based on a length of a PUSCH allocation associated with the PUSCH transmission.

Aspect 32: The method of any of aspects 27 through 31, wherein the one or two uplink symbols includes a first uplink symbol and a second uplink symbol, locations of the first uplink symbol and the second uplink symbol are defined via respective location parameters included in the rate matching information, the respective location parameters indicate the locations of the first uplink symbol and the second uplink symbol are based on positions of symbols that do not include a demodulation reference signal or a phase tracking reference signal within a PUSCH allocation associated with the PUSCH transmission.

Aspect 33: The method of any of aspects 3 through 32, wherein the rate matching information includes an index, a respective location for each uplink symbol of the one or two uplink symbols is based on the index, the index corresponds to a row of a time domain resource allocation table.

Aspect 34: The method of any of aspects 3 through 33, wherein rate matching information includes an index corresponding to particular information, the particular information includes a particular PUSCH mapping type, a particular slot location of the PUSCH transmission, a particular starting symbol, a particular length of the PUSCH transmission, and a respective location for each uplink symbol of the one or two uplink symbols.

Aspect 35: The method of aspect 34, wherein the index corresponds to a row of a time domain resource allocation table that includes the particular information.

Aspect 36: The method of any of aspects 3 through 35, wherein a respective location for each uplink symbol the one or two uplink symbols is based on a start and length indicator value.

Aspect 37: The method of aspect 36, wherein the start and length indicator value is for a time domain allocation corresponding to the PUSCH configuration information.

Aspect 38: The method of any of aspects 1 through 37, wherein the frequency-based rate matching pattern is configured during only a sub-band full-duplex (SBFD) slot in which the PUSCH transmission is scheduled.

Aspect 39: The method of aspect 38, wherein a maximum bandwidth available for the frequency-based rate matching pattern is an uplink sub-band in the SBFD slot.

Aspect 40: The method of any of aspects 1 through 39, wherein the frequency-based rate matching pattern is configured during either a sub-band full-duplex (SBFD) slot or a non-SBFD slot in which the PUSCH transmission is scheduled.

Aspect 41: The method of aspect 40, wherein a maximum bandwidth available for the frequency-based rate matching pattern in either the SBFD slot or the non-SBFD slot is an uplink sub-band in the SBFD slot.

Aspect 42: The method of any of aspects 40 through 41, wherein a maximum bandwidth available for the frequency-based rate matching pattern is based on an uplink sub-band in an SBFD slot in which the PUSCH transmission is scheduled, or an uplink sub-band in a non-SBFD slot in which the PUSCH transmission is scheduled.

Aspect 43: The method of any of aspects 40 through 42, further comprising: receiving information indicative of a maximum bandwidth available for the frequency-based rate matching pattern in either the SBFD slot or the non-SBFD slot, wherein the maximum bandwidth is at least equal to an uplink sub-band in the SBFD slot.

Aspect 44: The method of any of aspects 1 through 43, wherein the frequency-based rate matching pattern is a comb-2 pattern that is configured with a resource element (RE) offset.

Aspect 45: The method of aspect 44, further comprising: receiving the RE offset via a configuration message.

Aspect 46: The method of any of aspects 44 through 45, wherein the RE offset is a non-signaled RE offset.

Aspect 47: The method of any of aspects 1 through 46, further comprising: receiving a configuration message including a periodicity and a slot offset associated with the frequency-based rate matching pattern.

Aspect 48: The method of any of aspects 1 through 47, further comprising: receiving a configuration message including a time domain pattern associated with the frequency-based rate matching pattern.

Aspect 49: The method of any of aspects 1 through 48, wherein the frequency-based rate matching pattern is based on one or more fields, the one or more fields include a first field indicative of whether waveform switching is based on the frequency-based rate matching pattern, or a second field indicative of whether PUSCH repetition type-A, PUSCH repetition type-B, transport block processing over multi-slot (TBoMS) PUSCH, or DCI scheduling multiple PUSCH is based on the frequency-based rate matching pattern.

Aspect 50: The method of any of aspects 1 through 49, wherein, to transmit the PUSCH transmission based on the frequency-based rate matching pattern, the method further comprises: applying rate matching to the one or two symbols based on the frequency-based rate matching pattern.

Aspect 51: The method of any of aspects 1 through 50, wherein the frequency-based rate matching pattern is based on a comb-2 pattern for both discrete Fourier transform spread orthogonal frequency division multiplexing and cyclic prefix orthogonal frequency division multiplexing.

Aspect 52: The method of any of aspects 1 through 51, further comprising: receiving RRC information, wherein the RRC information includes the PUSCH configuration information.

Aspect 53: A method of wireless communication performed by a network entity, comprising: transmitting PUSCH configuration information including rate matching information; and receiving a PUSCH transmission based on a frequency-based rate matching pattern for one or more PUSCH transmissions, wherein the frequency-based rate matching pattern includes one or two symbols to which rate matching is to be applied.

Aspect 54: The method of aspect 53, wherein the PUSCH configuration information includes a parameter indicative that the rate matching information is configured for a second network entity.

Aspect 55: The method of any of aspects 53 through 54, wherein the rate matching information is indicative of one or two uplink symbols associated with the frequency-based rate matching pattern.

Aspect 56: The method of aspect 55, wherein the rate matching information includes a respective location for each uplink symbol of the one or two uplink symbols among a plurality of uplink symbols.

Aspect 57: The method of aspect 56, wherein locations for each uplink symbol of the plurality of uplink symbols are indicated in a bitmap, the plurality of uplink symbols in a slot are in accordance with the bitmap.

Aspect 58: The method of any of aspects 56 through 57, wherein the plurality of uplink symbols represents a slot.

Aspect 59: The method of aspect 58, wherein the plurality of uplink symbols includes 14 symbols.

Aspect 60: The method of any of aspects 56 through 59, wherein the one or two uplink symbols include a first uplink symbol and a second uplink symbol, and a threshold quantity of symbols exist between the first uplink symbol and the second uplink symbol.

Aspect 61: The method of aspect 60, wherein the respective location for the first uplink symbol is a first location and the respective location for the second uplink symbol is a second location.

Aspect 62: The method of any of aspects 55 through 61, wherein the one or two uplink symbols include a first uplink symbol, the rate matching information includes a location of the first uplink symbol among a first subset of two or more uplink symbols of a plurality of uplink symbols.

Aspect 63: The method of aspect 62, wherein the one or two uplink symbols includes a first uplink symbol and a second uplink symbol, the location of the first uplink symbol and a location of the second uplink symbol are indicated by an index included in the rate matching information, the index is associated with a symbol pattern.

Aspect 64: The method of any of aspects 62 through 63, wherein the plurality of uplink symbols represents a slot.

Aspect 65: The method of aspect 64, wherein the plurality of uplink symbols includes 14 symbols.

Aspect 66: The method of any of aspects 62 through 65, wherein the one or two uplink symbols include a second uplink symbol, and a second location of the second uplink symbol among the plurality of uplink symbols is based on the location of the first uplink symbol.

Aspect 67: The method of any of aspects 62 through 66, wherein the one or two uplink symbols include a second uplink symbol, and a second location of the second uplink symbol among the plurality of uplink symbols is based on an offset from the location of the first uplink symbol.

Aspect 68: The method of aspect 67, wherein the rate matching information includes the offset.

Aspect 69: The method of any of aspects 67 through 68, wherein the plurality of uplink symbols represents a slot.

Aspect 70: The method of aspect 69, wherein the plurality of uplink symbols includes 14 symbols.

Aspect 71: The method of any of aspects 55 through 70, wherein the one or two uplink symbols is based on relative locations of uplink symbols in a slot.

Aspect 72: The method of any of aspects 55 through 71, wherein the one or two uplink symbols include a first uplink symbol, a location of first uplink symbol among a plurality of uplink symbols is an Nth uplink symbol among the plurality of uplink symbols, and N is an integer greater than or equal to 1.

Aspect 73: The method of aspect 72, wherein the plurality of uplink symbols represents a slot.

Aspect 74: The method of any of aspects 55 through 73, wherein the one or two uplink symbols include a second uplink symbol, a location of second uplink symbol among a plurality of uplink symbols is an Mth uplink symbol among the plurality of uplink symbols, and M is an integer greater than N.

Aspect 75: The method of aspect 74, wherein the plurality of uplink symbols represents a slot.

Aspect 76: The method of aspect 75, wherein the plurality of uplink symbols includes 14 symbols.

Aspect 77: The method of any of aspects 55 through 76, wherein the one or two uplink symbols includes a first uplink symbol and a second uplink symbol, locations of the first uplink symbol and the second uplink symbol are fixed.

Aspect 78: The method of any of aspects 55 through 77, wherein the rate matching information includes a respective location for each uplink symbol of the one or two uplink symbols among a plurality of uplink symbols, the respective location for each uplink symbol of the one or two uplink symbols is based on a PUSCH allocation associated with the PUSCH transmission.

Aspect 79: The method of aspect 78, wherein the plurality of uplink symbols represents a slot.

Aspect 80: The method of aspect 79, wherein the plurality of uplink symbols includes 14 symbols.

Aspect 81: The method of any of aspects 78 through 80, wherein the one or two uplink symbols includes a first uplink symbol and a second uplink symbol, locations of the first uplink symbol and the second uplink symbol are defined via respective location parameters included in the rate matching information, the respective location parameters indicate the locations of the first uplink symbol and the second uplink symbol based on demodulation reference signal position within a PUSCH allocation associated with the PUSCH transmission.

Aspect 82: The method of any of aspects 78 through 81, wherein the one or two uplink symbols includes a first uplink symbol and a second uplink symbol, locations of the first uplink symbol and the second uplink symbol are defined via respective location parameters included in the rate matching information, the respective location parameters indicate the locations of the first uplink symbol and the second uplink symbol are based on a length of a PUSCH allocation associated with the PUSCH transmission.

Aspect 83: The method of any of aspects 78 through 82, wherein the one or two uplink symbols includes a first uplink symbol and a second uplink symbol, locations of the first uplink symbol and the second uplink symbol are defined via respective location parameters included in the rate matching information, the respective location parameters indicate the locations of the first uplink symbol and the second uplink symbol are based on positions of symbols that do not include a demodulation reference signal or a phase tracking reference signal within a PUSCH allocation associated with the PUSCH transmission.

Aspect 84: The method of any of aspects 55 through 83, wherein the rate matching information includes an index, a respective location for each uplink symbol of the one or two uplink symbols is based on the index, the index corresponds to a row of a time domain resource allocation table.

Aspect 85: The method of any of aspects 55 through 84, wherein rate matching information includes an index corresponding to particular information, the particular information includes a particular PUSCH mapping type, a particular slot location of the PUSCH transmission, a particular starting symbol, a particular length of the PUSCH transmission, and a respective location for each uplink symbol of the one or two uplink symbols.

Aspect 86: The method of aspect 85, wherein the index corresponds to a row of a time domain resource allocation table that includes the particular information.

Aspect 87: The method of any of aspects 55 through 86, wherein a respective location for each uplink symbol the one or two uplink symbols is based on a start and length indicator value.

Aspect 88: The method of aspect 87, wherein the start and length indicator value is for a time domain allocation corresponding to the PUSCH configuration information.

Aspect 89: The method of any of aspects 53 through 88, wherein the frequency-based rate matching pattern is configured during only a sub-band full-duplex (SBFD) slot in which the PUSCH transmission is scheduled.

Aspect 90: The method of aspect 89, wherein a maximum bandwidth available for the frequency-based rate matching pattern is an uplink sub-band in the SBFD slot.

Aspect 91: The method of any of aspects 53 through 90, wherein the frequency-based rate matching pattern is configured during either a sub-band full-duplex (SBFD) slot or a non-SBFD slot in which the PUSCH transmission is scheduled.

Aspect 92: The method of aspect 91, wherein a maximum bandwidth available for the frequency-based rate matching pattern in either the SBFD slot or the non-SBFD slot is an uplink sub-band in the SBFD slot.

Aspect 93: The method of any of aspects 91 through 92, wherein a maximum bandwidth available for the frequency-based rate matching pattern is based on an uplink sub-band in an SBFD slot in which the PUSCH transmission is scheduled, or an uplink sub-band in a non-SBFD slot in which the PUSCH transmission is scheduled.

Aspect 94: The method of any of aspects 91 through 93, further comprising: transmitting information indicative of a maximum bandwidth available for the frequency-based rate matching pattern in either the SBFD slot or the non-SBFD slot, wherein the maximum bandwidth is at least equal to an uplink sub-band in the SBFD slot.

Aspect 95: The method of any of aspects 53 through 94, wherein the frequency-based rate matching pattern is a comb-2 pattern that is configured with a resource element (RE) offset.

Aspect 96: The method of aspect 95, further comprising: transmitting the RE offset via a configuration message.

Aspect 97: The method of any of aspects 95 through 96, wherein the RE offset is a non-signaled RE offset.

Aspect 98: The method of any of aspects 53 through 97, further comprising: transmitting a configuration message including a periodicity and a slot offset associated with the frequency-based rate matching pattern.

Aspect 99: The method of any of aspects 53 through 98, further comprising: transmitting a configuration message including a time domain pattern associated with the frequency-based rate matching pattern.

Aspect 100: The method of any of aspects 53 through 99, wherein the frequency-based rate matching pattern is based on one or more fields, the one or more fields include a first field indicative of whether waveform switching is based on the frequency-based rate matching pattern, or a second field indicative of whether PUSCH repetition type-A, PUSCH repetition type-B, transport block processing over multi-slot (TBoMS) PUSCH, or DCI scheduling multiple PUSCH is based on the frequency-based rate matching pattern.

Aspect 101: The method of any of aspects 53 through 100, wherein the PUSCH transmission is in accordance with rate matching to the one or two symbols based on the frequency-based rate matching pattern.

Aspect 102: The method of any of aspects 53 through 101, wherein the frequency-based rate matching pattern is based on a comb-2 pattern for both discrete Fourier transform spread orthogonal frequency division multiplexing and cyclic prefix orthogonal frequency division multiplexing.

Aspect 103: The method of any of aspects 53 through 102, further comprising: transmitting RRC information, wherein the RRC information includes the PUSCH configuration information.

Aspect 104: A network entity comprising one or more memories storing processor-executable code, and one or more processors coupled with the one or more memories and individually or collectively operable to execute the code to cause the network entity to perform a method of any of aspects 1 through 52.

Aspect 105: A network entity comprising at least one means for performing a method of any of aspects 1 through 52.

Aspect 106: A non-transitory computer-readable medium storing code the code comprising instructions executable by one or more processors to perform a method of any of aspects 1 through 52.

Aspect 107: A network entity comprising one or more memories storing processor-executable code, and one or more processors coupled with the one or more memories and individually or collectively operable to execute the code to cause the network entity to perform a method of any of aspects 53 through 103.

Aspect 108: A network entity comprising at least one means for performing a method of any of aspects 53 through 103.

Aspect 109: A non-transitory computer-readable medium storing code the code comprising instructions executable by one or more processors to perform a method of any of aspects 53 through 103.

The methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium.

Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

Additionally, a “set” refers to one or more items unless specifically disclosed differently (e.g., a set of a plurality of items), and a “subset” refers to a non-empty portion that is less than a whole set unless specifically disclosed to the differently (e.g., a subset of zero or more items of the set one or more items).

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
a processing system configured to:
receive physical uplink shared channel (PUSCH) configuration information including rate matching information, wherein the rate matching information is indicative of one or two uplink symbols associated with a frequency-based rate matching pattern and includes an index corresponding to particular information, wherein the particular information includes a particular PUSCH mapping type, a particular slot location of a PUSCH transmission, a particular starting symbol, a particular length for the PUSCH transmission, and a respective location for each uplink symbol of the one or two uplink symbols;
determine, based on the rate matching information, the frequency-based rate matching pattern for the PUSCH transmission, wherein the frequency-based rate matching pattern includes the one or two uplink symbols to which rate matching is to be applied; and
transmit the PUSCH transmission based on the frequency-based rate matching pattern.

2. The network entity of claim 1, wherein the index corresponds to a row of a time domain resource allocation table that includes the particular information.

3. The network entity of claim 2, wherein the processing system is configured to:
receive a radio resource control (RRC) configuration message indicative of different frequency-based rate matching patterns of the time domain resource allocation table.

4. The network entity of claim 3, wherein the frequency-based rate matching pattern is configured during only a sub-band full-duplex (SBFD) slot in which the PUSCH transmission is scheduled, or is configured during either an SBFD slot or a non-SBFD slot in which the PUSCH transmission is scheduled.

5. The network entity of claim 4, wherein a maximum bandwidth available for the frequency-based rate matching pattern is based on an uplink sub-band in the SBFD slot in which the PUSCH transmission is scheduled, or an uplink sub-band in the non-SBFD slot in which the PUSCH transmission is scheduled.

6. The network entity of claim 1, wherein the processing system is configured to:
receive a resource element (RE) offset via a configuration message, wherein the frequency-based rate matching pattern is a comb-2 pattern that is configured via the RE offset.

7. The network entity of claim 1, wherein, to transmit the PUSCH transmission based on the frequency-based rate matching pattern, the processing system is configured to:
apply rate matching to the one or two uplink symbols based on the frequency-based rate matching pattern.

8. A network entity for wireless communication, comprising:
a processing system configured to:
receive a radio resource control (RRC) configuration message indicative of a configuration for a physical uplink shared channel (PUSCH) with one or two uplink symbols for which uplink muting is to be applied;
receive information indicative of the one or two uplink symbols for which uplink muting is to be applied when uplink muting is active, wherein the one or two uplink symbols are determined based on a time domain resource allocation table indicative of the one or two uplink symbols; and
transmit a PUSCH transmission with uplink muting applied to the one or two uplink symbols.

9. The network entity of claim 8, wherein the one or two uplink symbols are determined based on rate matching information associated with a frequency-based rate matching pattern.

10. The network entity of claim 9, wherein the rate matching information includes an index corresponding to particular information, wherein the particular information includes a particular PUSCH mapping type, a particular slot location of the PUSCH transmission, a particular starting symbol, a particular length of the PUSCH transmission, and a respective location for each uplink symbol of the one or two uplink symbols.

11. The network entity of claim 10, wherein the index corresponds to a row of the time domain resource allocation table that includes the particular information.

12. The network entity of claim 9, wherein the frequency-based rate matching pattern is configured during only a sub-band full-duplex (SBFD) slot in which the PUSCH transmission is scheduled, or is configured during either an SBFD slot or a non-SBFD slot in which the PUSCH transmission is scheduled.

13. The network entity of claim 12, wherein a maximum bandwidth available for the frequency-based rate matching pattern is based on an uplink sub-band in the SBFD slot in which the PUSCH transmission is scheduled, or an uplink sub-band in the non-SBFD slot in which the PUSCH transmission is scheduled.

14. The network entity of claim 9, wherein the frequency-based rate matching pattern is a comb-2 pattern that is configured via a resource element (RE) offset.

15. The network entity of claim 8, wherein the PUSCH transmission is based on a frequency-based rate matching pattern, and the processing system is configured to:
apply rate matching to the one or two uplink symbols based on the frequency-based rate matching pattern.

16. A network entity for wireless communication, comprising:
a processing system configured to:
receive a radio resource control (RRC) configuration message indicative of a configuration for a physical uplink shared channel (PUSCH) with one or two uplink symbols for which uplink muting is to be applied; and
transmit a PUSCH transmission with uplink muting applied to the one or two uplink symbols when uplink muting is active, wherein the PUSCH transmission is based on a time domain resource allocation table indicative of the one or two uplink symbols.

17. The network entity of claim 16, wherein the one or two uplink symbols are determined based on rate matching information associated with a frequency-based rate matching pattern.

18. The network entity of claim 17, wherein the rate matching information includes an index corresponding to particular information, wherein the particular information includes a particular PUSCH mapping type, a particular slot location of the PUSCH transmission, a particular starting symbol, a particular length of the PUSCH transmission, and a respective location for each uplink symbol of the one or two uplink symbols.

19. The network entity of claim 18, wherein the index corresponds to a row of the time domain resource allocation table that includes the particular information.

20. The network entity of claim 17, wherein the frequency-based rate matching pattern is configured during only a sub-band full-duplex (SBFD) slot in which the PUSCH transmission is scheduled, or is configured during either an SBFD slot or a non-SBFD slot in which the PUSCH transmission is scheduled.
